(19) United States
(12) Patent Application Publication
(10) Pub. No.: US 2002/0107962 A1
(43) Pub. Date: Aug. 8, 2002

(54) Single chassis network endpoint system with network processor for load balancing

(76) Inventors: Roger K. Richter, Leander, TX (US); Brian W. Bailey, Austin, TX (US); Ho Wang, Austin, TX (US)

Correspondence Address: Richard D. Egan, O'KEEFE, EGAN & PETERMAN, 1101 Capital of Texas Highway South, Building C, Suite 200, Austin, TX, 78746, US

(21) Appl. No.: 09/797,507

(22) Filed: Mar. 1, 2001

Related U.S. Application Data
(60) Provisional application No. 60/246,372, filed on Nov. 7, 2000.

(51) Int. Cl. G06F 15/173; G06F 15/16

(52) U.S. Cl. 709/225; 709/231

(57) ABSTRACT

A network processing endpoint system for responding to network requests via a network is provided. A network processor is programmed to receive network requests and to provide load balancing of the network requests or workloads. The network processor distributes network requests to a set of processing units, which are programmed to respond to the requests. An interconnection medium, which may be a system bus, a switch fabric, or shared memory, directly connects the network processor to the processing units, such that the paths and latencies of the connections are deterministic. Hardware load balancing of the processing units may also be accomplished through the assignment or re-assignment of the processing units to specific tasks to be performed.

This application claims priority from Provisional Application Serial No. 60/246,372 filed on Nov. 7, 2000, which is entitled SINGLE CHASSIS NETWORK ENDPOINT SYSTEM WITH NETWORK PROCESSOR FOR LOAD BALANCING,” the disclosure of which is being incorporated herein by reference.

### BACKGROUND OF THE INVENTION

This invention relates to computer networks, and more particularly to a network endpoint system that uses a network processor to distribute network sessions among multiple processing units.

In today's computer networking world, bandwidths are moving rapidly toward the gigabit per second (Gbps) range, due in part to the deployment of fiber optic media. Conventional network server technology does not meet the demands for processing data at these rates in a cost effective manner. To handle the growing data rates, most network content providers have deployed a set of identical autonomous computers that all run in parallel “behind” a network switch that distributes the network data traffic to the computers, using various load balancing schemes. The connections between the switch and the computers are “network connections” with indeterminable paths and latencies.

The above-described load balancing approach is predominant in the Internet. The network connections are distributed within a set of independent computers that then operate in parallel. This is a workable but costly solution because large sets of computer systems, each with its own power supply, processors, memory, storage media, and chassis must be managed and maintained.

### SUMMARY OF THE INVENTION

One aspect of the invention is a network processing endpoint system for responding to network requests via a network. A network processor is programmed to receive network requests or workloads and to provide load balancing of the network requests. The network processor distributes network requests to a set of processing units, which are programmed to respond to the requests. An interconnection medium, which may be a system bus, a switch fabric, or shared memory, directly connects the network processor to the processing units, such that the paths and latencies of the connections are deterministic. Hardware load balancing of the processing units may also be accomplished through the assignment or reassignment of the processing units to specific tasks to be performed.

An advantage of the invention is that the endpoint system can be easily housed in a single chassis. This greatly simplifies and reduces the cost of the system. The network processor permits connections with multiple processing units by means of the internal interconnection medium. In this same sense, more than one chassis may be easily interconnected.

The interconnection medium used to connect the network processor to the processing units results in connections whose latencies are bounded and known. This enables load balancing to be implemented deterministically with the ability to provide additional network and data traffic services such as priority and filtering policies.

### DESCRIPTION OF THE FIGURES

FIG. 1A is a representation of components of a content delivery system according to one embodiment of the disclosed content delivery system.

FIG. 1B is a representation of data flow between modules of a content delivery system of FIG. 1A according to one embodiment of the disclosed content delivery system.

FIG. 1C is a simplified schematic diagram showing one possible network content delivery system hardware configuration.

FIG. 1D is a simplified schematic diagram showing a network content delivery engine configuration possible with the network content delivery system hardware configuration of FIG. 1C.

FIG. 1E is a simplified schematic diagram showing an alternate network content delivery engine configuration possible with the network content delivery system hardware configuration of FIG. 1C.

FIG. 1F is a simplified schematic diagram showing another alternate network content delivery engine configuration possible with the network content delivery system hardware configuration of FIG. 1C.

FIGS. 1G-1J illustrate exemplary clusters of network content delivery systems.

FIG. 2 is a simplified schematic diagram showing another possible network content delivery system configuration.

FIG. 2A is a simplified schematic diagram showing a network endpoint computing system.

FIG. 2B is a simplified schematic diagram showing a network endpoint computing system.

FIG. 3 is a functional block diagram of an exemplary network processor.

FIG. 4 is a functional block diagram of an exemplary interface between a switch fabric and a processor.

### DETAILED DESCRIPTION OF THE INVENTION

Disclosed herein are systems and methods for operating network connected computing systems. The network connected computing systems disclosed provide a more efficient use of computing system resources and provide improved performance as compared to traditional network connected computing systems. Network connected computing systems may include network endpoint systems. The systems and methods disclosed herein may be particularly beneficial for use in network endpoint systems. Network endpoint systems may include a wide variety of computing devices, including but not limited to, classic general purpose servers, specialized servers, network appliances, storage area networks or other storage medium, content delivery systems, corporate data centers, application service providers, home or laptop computers, clients, any other device that operates as an endpoint network connection, etc.

Other network connected systems may be considered a network intermediate node system. Such systems are generally connected to some node of a network that may operate in some other fashion than an endpoint. Typical examples include network switches or network routers. Network intermediate node systems may also include any other devices coupled to intermediate nodes of a network.

Further, some devices may be considered both a network intermediate node system and a network endpoint system. Such hybrid systems may perform both endpoint functionality and intermediate node functionality in the same device. For example, a network switch that also performs some endpoint functionality may be considered a hybrid system. As used herein such hybrid devices are considered to be a network endpoint system and are also considered to be a network intermediate node system.

For ease of understanding, the systems and methods disclosed herein are described with regards to an illustrative network connected computing system. In the illustrative example the system is a network endpoint system optimized for a content delivery application. Thus a content delivery system is provided as an illustrative example that demonstrates the structures, methods, advantages and benefits of the network computing system and methods disclosed herein. Content delivery systems (such as systems for serving streaming content, HTTP content, cached content, etc.) generally have intensive input/output demands.

It will be recognized that the hardware and methods discussed below may be incorporated into other hardware or applied to other applications. For example with respect to hardware, the disclosed system and methods may be utilized in network switches. Such switches may be considered to be intelligent or smart switches with expanded functionality beyond a traditional switch. Referring to the content delivery application described in more detail herein, a network switch may be configured to also deliver at least some content in addition to traditional switching functionality. Thus, though the system may be considered primarily a network switch (or some other network intermediate node device), the system may incorporate the hardware and methods disclosed herein. Likewise a network switch performing applications other than content delivery may utilize the systems and methods disclosed herein. The nomenclature used for devices utilizing the concepts of the present invention may vary. The network switch or router that includes the content delivery system disclosed herein may be called a network content switch or a network content router or the like. Independent of the nomenclature assigned to a device, it will be recognized that the network device may incorporate some or all of the concepts disclosed herein.

The disclosed hardware and methods also may be utilized in storage area networks, network attached storage, channel attached storage systems, disk arrays, tape storage systems, direct storage devices or other storage systems. In this case, a storage system having the traditional storage system functionality may also include additional functionality utilizing the hardware and methods shown herein. Thus, although the system may primarily be considered a storage system, the system may still include the hardware and methods disclosed herein. The disclosed hardware and methods of the present invention also may be utilized in traditional personal computers, portable computers, servers, workstations, mainframe computer systems, or other computer systems. In this case, a computer system having the traditional computer system functionality associated with the particular type of computer system may also include additional functionality utilizing the hardware and methods shown herein. Thus, although the system may primarily be considered to be a particular type of computer system, the system may still include the hardware and methods disclosed herein.

As mentioned above, the benefits of the present invention are not limited to any specific tasks or applications. The content delivery applications described herein are thus illustrative only. Other tasks and applications that may incorporate the principles of the present invention include, but are not limited to, database management systems, application service providers, corporate data centers, modeling and simulation systems, graphics rendering systems, other complex computational analysis systems, etc. Although the principles of the present invention may be described with respect to a specific application, it will be recognized that many other tasks or applications performed with the hardware and methods.

Disclosed herein are systems and methods for delivery of content to computer-based networks that employ functional multi-processing using a “staged pipeline” content delivery environment to optimize bandwidth utilization and accelerate content delivery while allowing greater determination in the data traffic management. The disclosed systems may employ individual modular processing engines that are optimized for different layers of a software stack. Each individual processing engine may be provided with one or more discrete subsystem modules configured to run on their own optimized platform and/or to function in parallel with one or more other subsystem modules across a high speed distributive interconnect, such as a switch fabric, that allows peer-to-peer communication between individual subsystem modules. The use of discrete subsystem modules that are distributively interconnected in this manner advantageously allows individual resources (e.g., processing resources, memory resources) to be deployed by sharing or reassignment in order to maximize acceleration of content delivery by the content delivery system. The use of a scalable packet-based interconnect, such as a switch fabric, advantageously allows the installation of additional subsystem modules without significant degradation of system performance. Furthermore, policy enhancement/enforcement may be optimized by placing intelligence in each individual modular processing engine.

The network systems disclosed herein may operate as network endpoint systems. Examples of network endpoints include, but are not limited to, servers, content delivery systems, storage systems, application service providers, database management systems, corporate data center servers, etc. A client system is also a network endpoint, and its resources may typically range from those of a general purpose computer to the simpler resources of a network appliance. The various processing units of the network endpoint system may be programmed to achieve the desired type of endpoint.

Some embodiments of the network endpoint systems disclosed herein are network endpoint content delivery systems. The network endpoint content delivery systems may be utilized in replacement of or in conjunction with traditional network servers. A “server” can be any device that delivers content, services, or both. For example, a content delivery server receives requests for content from remote browser clients via the network, accesses a file system to retrieve the requested content, and delivers the content to the client. As another example, an applications server may be programmed to execute applications software on behalf of a remote client, thereby creating data for use by the client. Various server appliances are being developed and often perform specialized tasks.

As will be described more fully below, the network endpoint system disclosed herein may include the use of network processors. Though network processors conventionally are designed and utilized at intermediate network nodes, the network endpoint system disclosed herein adapts this type of processor for endpoint use.

The network endpoint system disclosed may be construed as a switch based computing system. The system may further be characterized as an asymmetric multi-processor system configured in a staged pipeline manner.

Exemplary System Overview

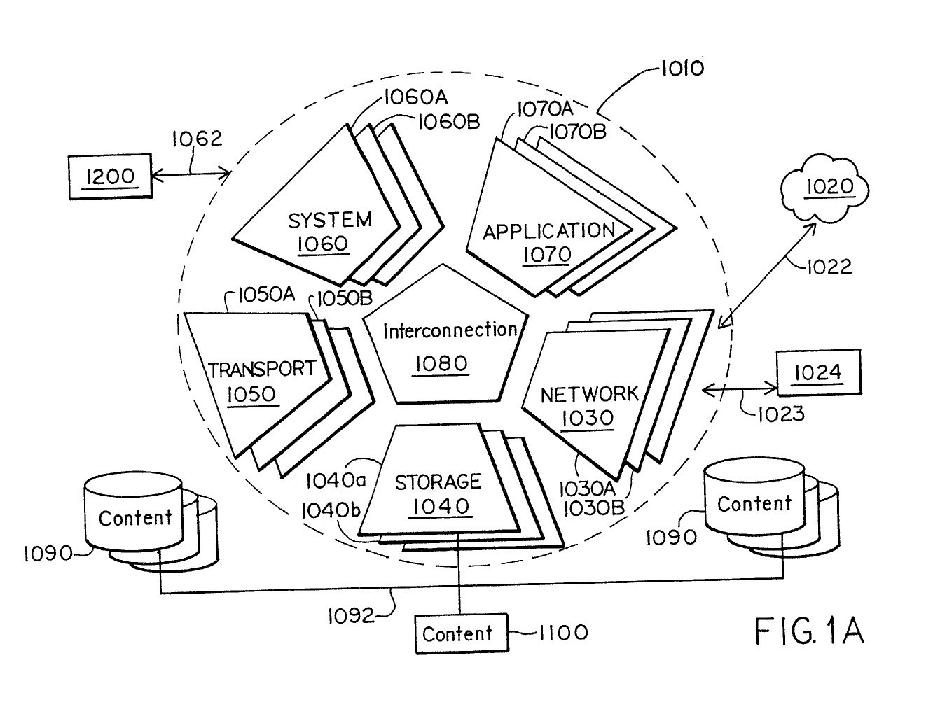

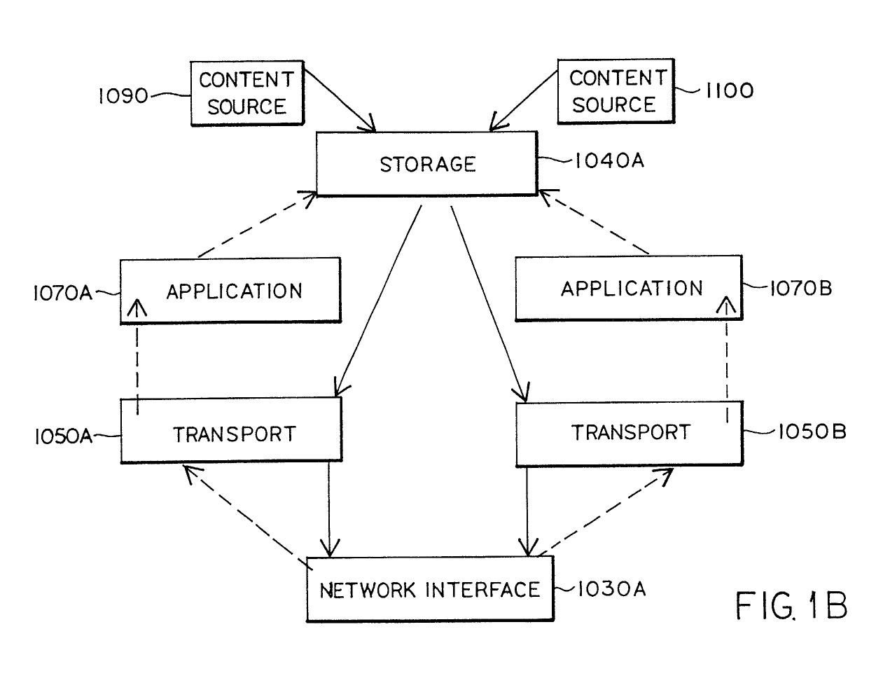

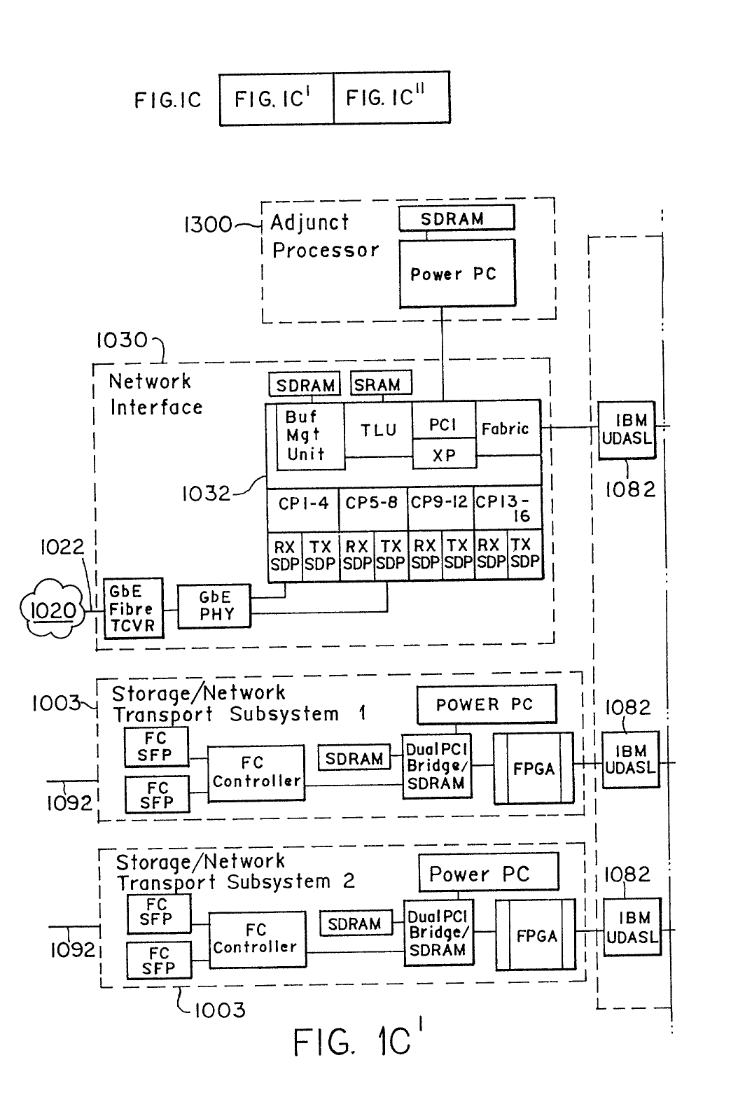

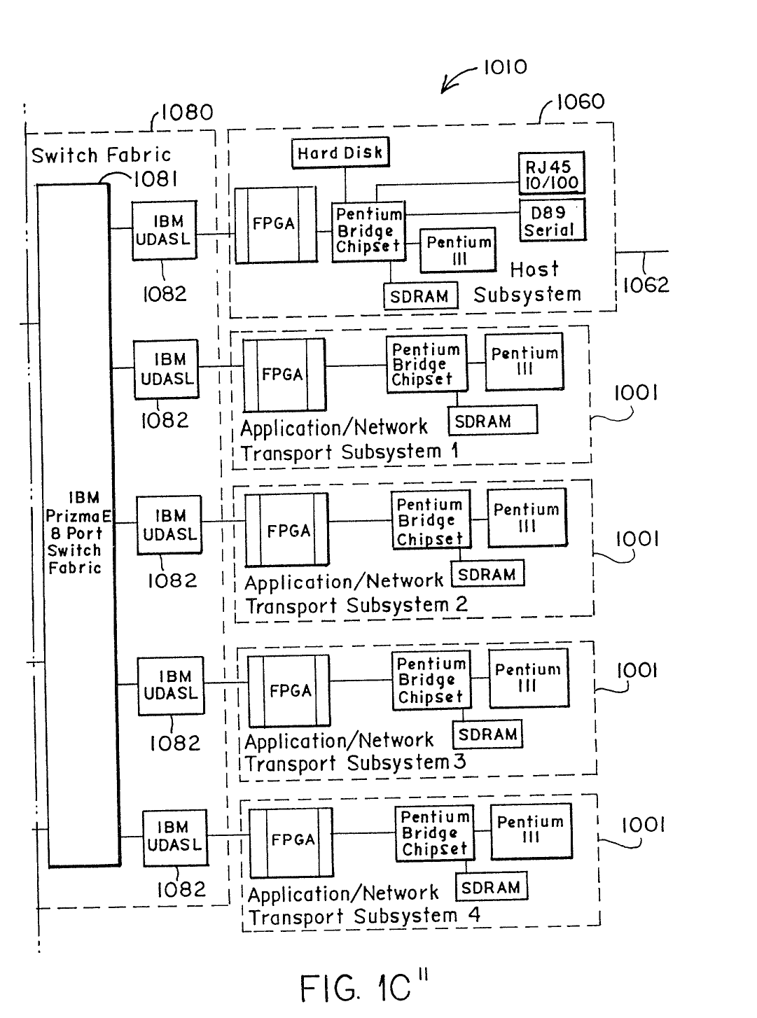

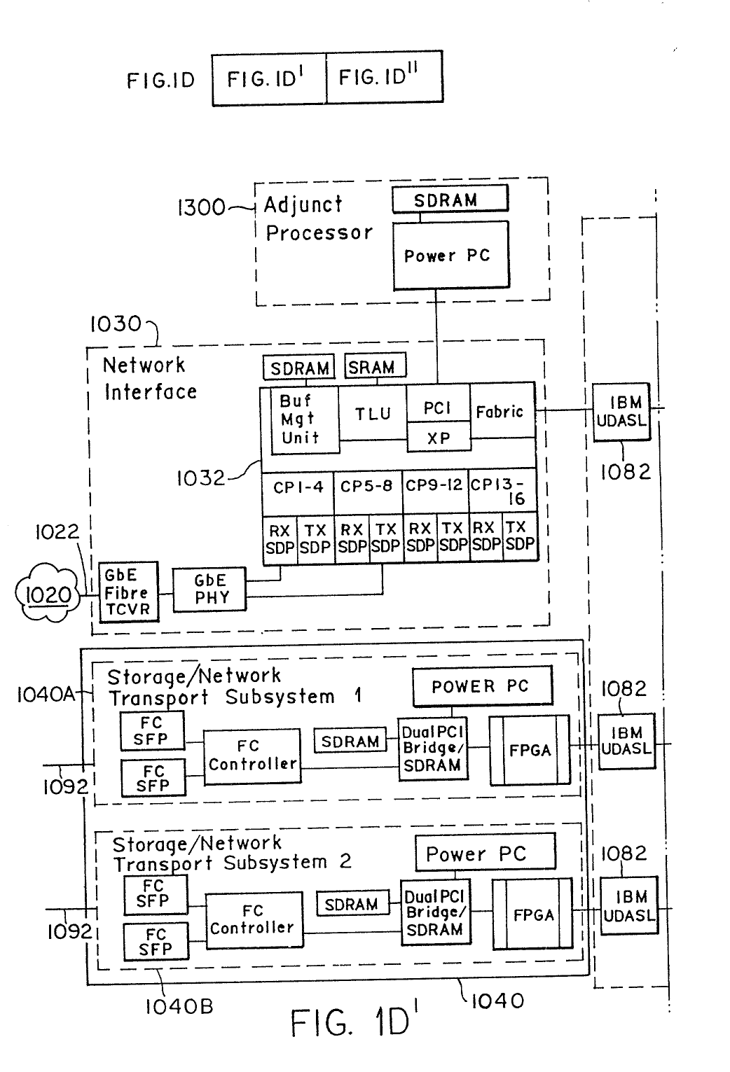

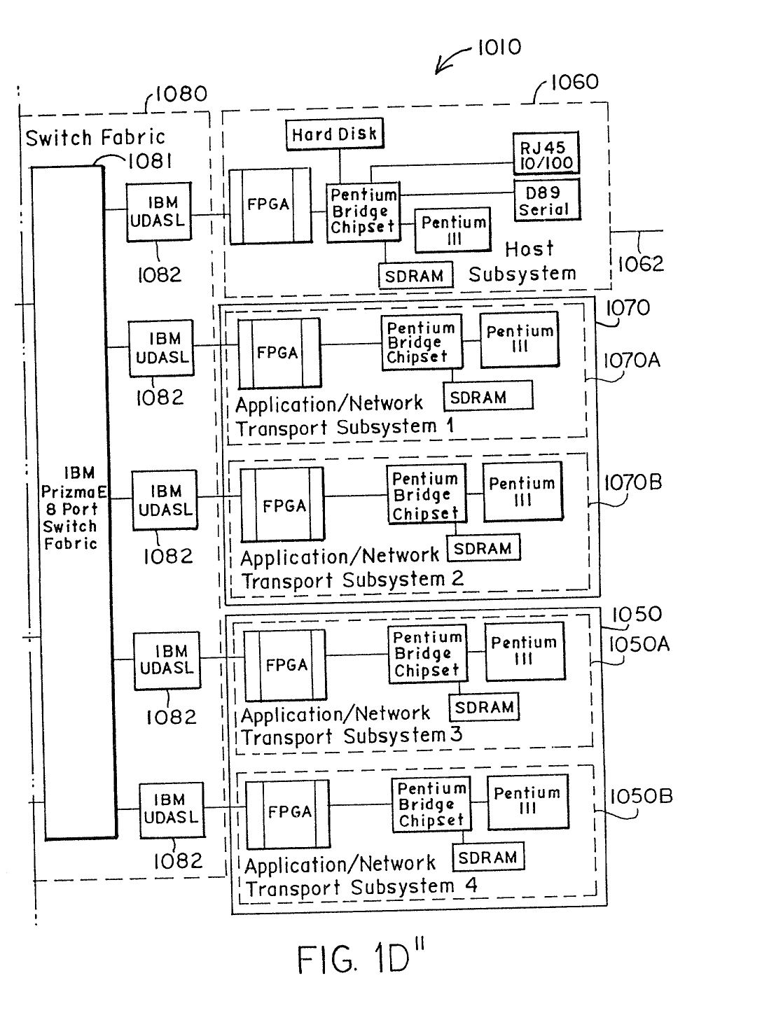

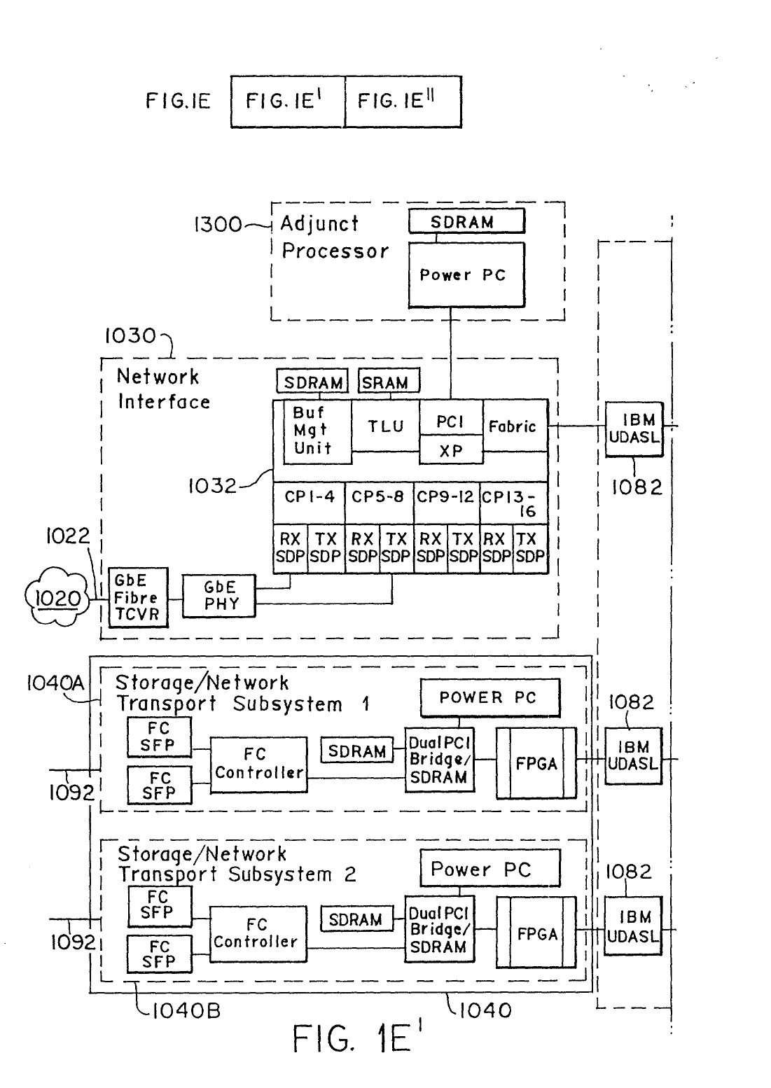

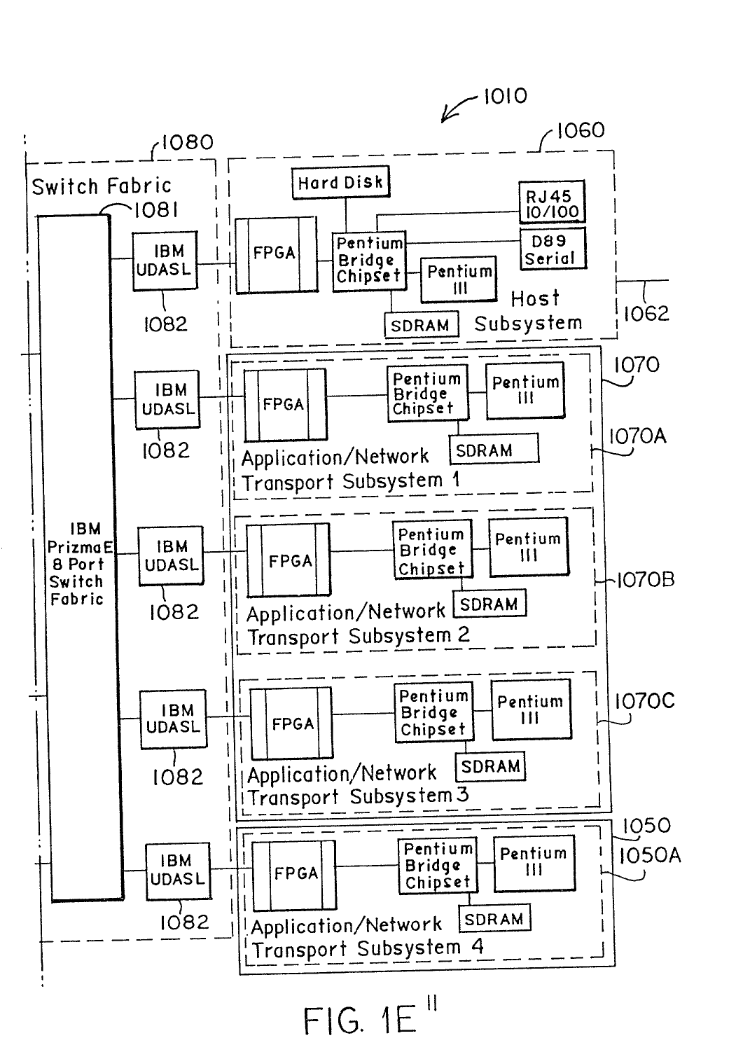

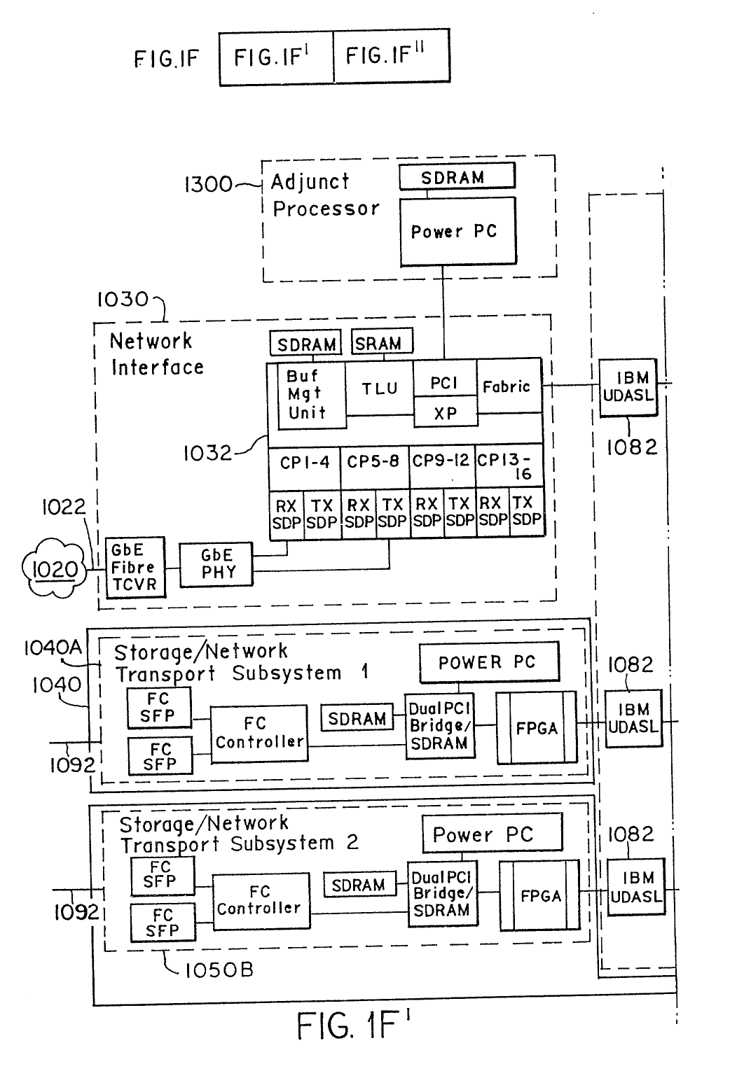

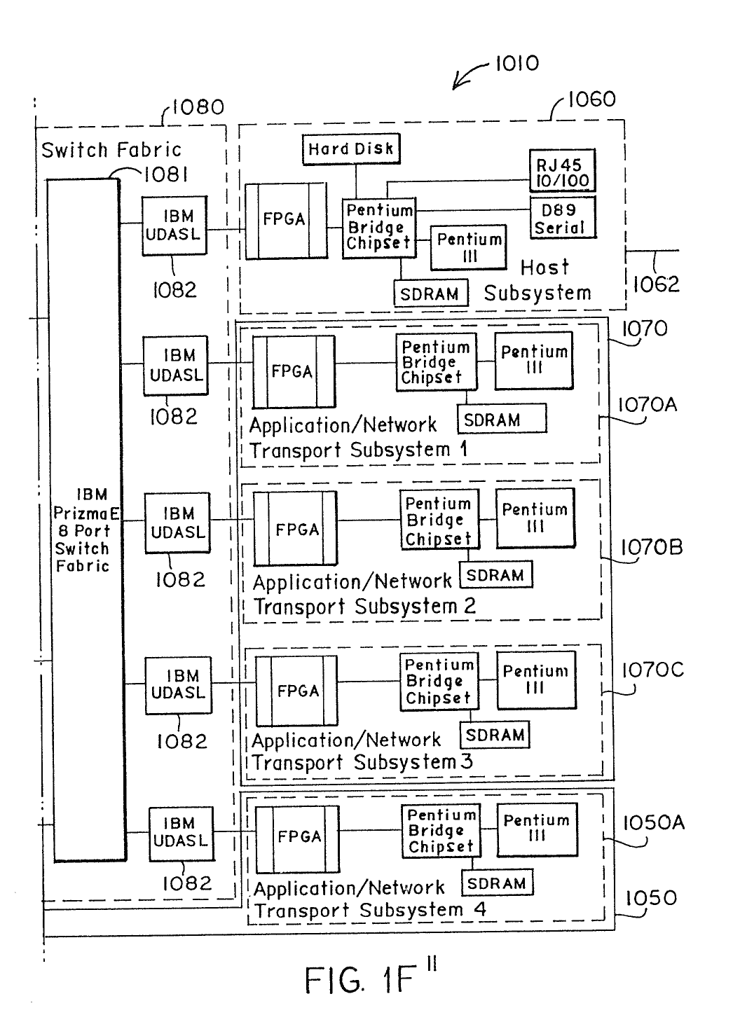

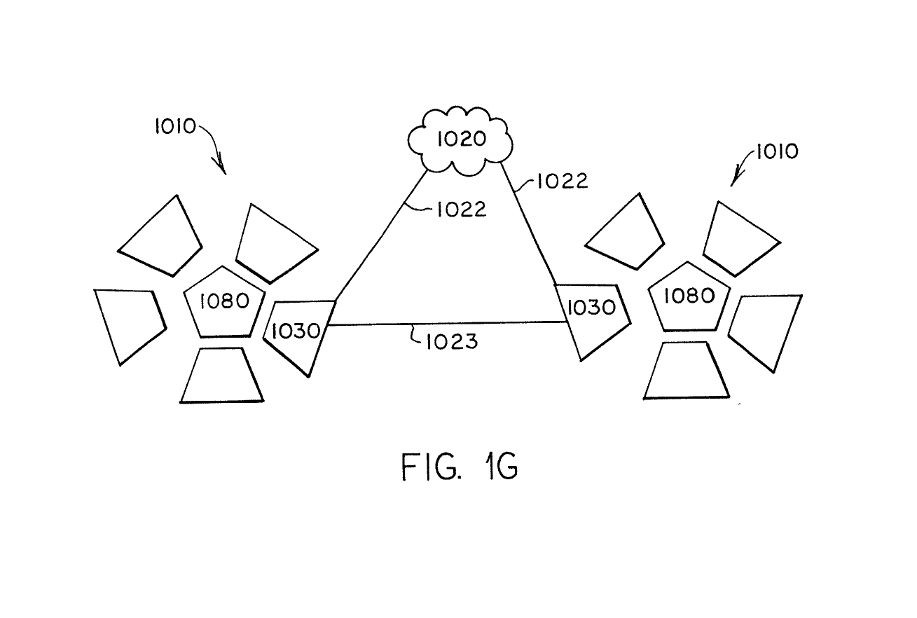

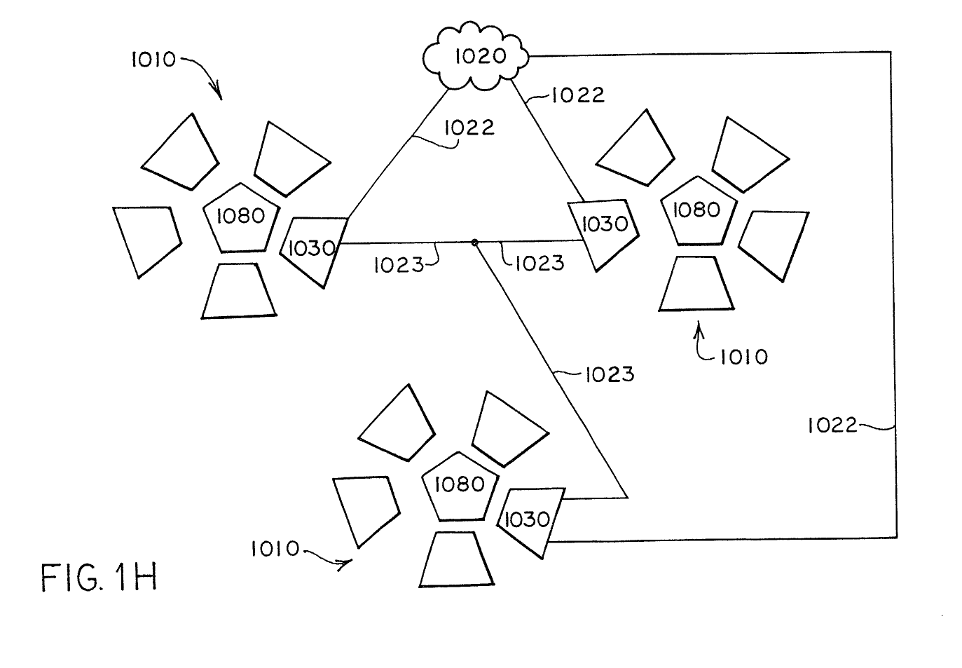

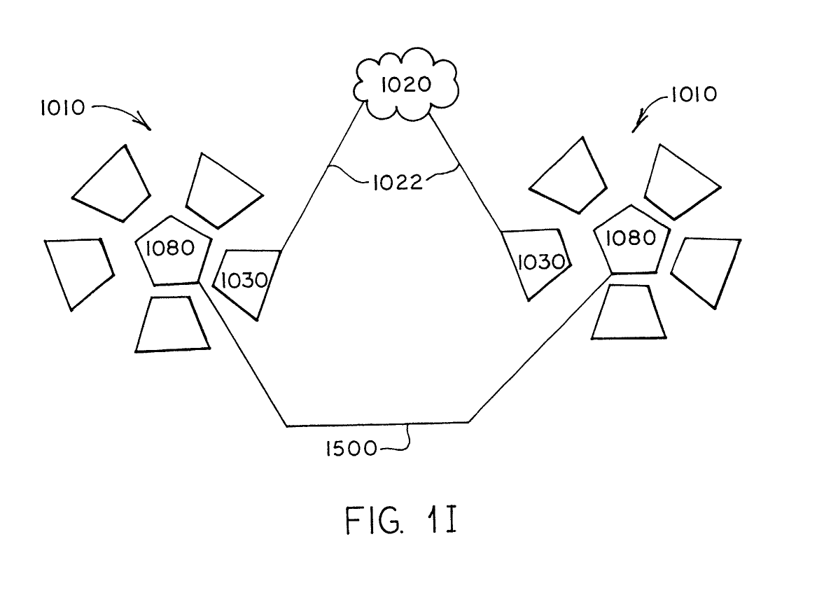

FIG. 1A is a representation of one embodiment of a content delivery system 1010, for example as may be employed as a network endpoint system in connection with a network 1020. Network 1020 may be any type of computer network suitable for linking computing systems. Content delivery system 1010 may be coupled to one or more networks including, but not limited to, the public internet, a private intranet network (e.g., linking users and hosts such as employees of a corporation or institution), a wide area network (WAN), a local area network (LAN), a wireless network, any other client based network or any other network environment of connected computer systems or online users. Thus, the data provided from the network 1020 may be in any networking protocol. In one embodiment, network 1020 may be the public internet that serves to provide access to content delivery system 1010 by multiple online users that utilize internet web browsers on personal computers operating through an internet service provider. In this case the data is assumed to follow one or more of various Internet Protocols, such as TCP/IP, UDP, HTTP, RTSP, SSL, FTP, etc. However, the same concepts apply to networks using other existing or future protocols, such as IPX, SNMP, NetBios, Ipv6, etc. The concepts may also apply to file protocols such as network file system (NFS) or common internet file system (CIFS) file sharing protocol.

Examples of content that may be delivered by content delivery system 1010 include, but are not limited to, static content (e.g., web pages, MP3 files, HTTP object files, audio stream files, video stream files, etc.), dynamic content, etc. In this regard, static content may be defined as content available to content delivery system 1010 via attached storage devices and as content that does not generally require any processing before delivery. Dynamic content, on the other hand, may be defined as content that either requires processing before delivery, or resides remotely from content delivery system 1010. As illustrated in FIG. 1A, content sources may include, but are not limited to, one or more storage devices 1090 (magnetic disks, optical disks, tapes, storage area networks (SAN's), etc.), other content sources 1100, third party remote content feeds, broadcast sources (live direct audio or video broadcast feeds, etc.), delivery of cached content, combinations thereof, etc. Broadcast or remote content may be advantageously received through second network connection 1023 and delivered to network 1020 via an accelerated flowpath through content delivery system 1010. As discussed below, second network connection 1023 may be connected to a second network 1024 (as shown). Alternatively, both network connections 1022 and 1023 may be connected to network 1020.

As shown in FIG. 1A, one embodiment of content delivery system 1010 includes multiple system engines 1030, 1040, 1050, 1060, and 1070 communicatively coupled via distributive interconnection 1080. In the exemplary embodiment provided, these system engines operate as content delivery engines. As used herein, “content delivery engine” generally includes any hardware, software or hardware/software combination capable of performing one or more dedicated tasks or sub-tasks associated with the delivery or transmittal of content from one or more content sources to one or more networks. In the embodiment illustrated in FIG. 1A content delivery processing engines (or “processing blades”) include network interface processing engine 1030, storage processing engine 1040, network transport/protocol processing engine 1050 (referred to hereafter as a transport processing engine), system management processing engine 1060, and application processing engine 1070. Thus configured, content delivery system 1010 is capable of providing multiple dedicated and independent processing engines that are optimized for networking, storage and application protocols, each of which is substantially self-contained and therefore capable of functioning without consuming resources of the remaining processing engines.

It will be understood with benefit of this disclosure that the particular number and identity of content delivery engines illustrated in FIG. 1A are illustrative only, and that for any given content delivery system 1010 the number and/or identity of content delivery engines may be varied to fit particular needs of a given application or installation. Thus, the number of engines employed in a given content delivery system may be greater or fewer in number than illustrated in FIG. 1A, and/or the selected engines may include other types of content delivery engines and/or may not include all of the engine types illustrated in FIG. 1A. In one embodiment, the content delivery system 1010 may be implemented within a single chassis, such as for example, a 2U chassis.

Content delivery engines 1030, 1040, 1050, 1060 and 1070 are present to independently perform selected sub-tasks associated with content delivery from content sources 1090 and/or 1100, it being understood however that in other embodiments any one or more of such subtasks may be combined and performed by a single engine, or subdivided to be performed by more than one engine. In one embodiment, each of engines 1030, 1040, 1050, 1060 and 1070 may employ one or more independent processor modules (e.g., CPU modules) having independent processor and memory subsystems and suitable for performance of a given function/s, allowing independent operation without interference from other engines or modules. Advantageously, this allows custom selection of particular processor-types based on the particular sub-task each is to perform, and in consideration of factors such as speed or efficiency in performance of a given subtask, cost of individual processor, etc. The processors utilized may be any processor suitable for adapting to endpoint processing. Any “PC on a board” type device may be used, such as the x86 and Pentium processors from Intel Corporation, the SPARC processor from Sun Microsystems, Inc., the PowerPC processor from Motorola, Inc. or any other microcontroller or microprocessor. In addition, network processors (discussed in more detail below) may also be utilized. The modular multi-task configuration of content delivery system 1010 allows the number and/or type of content delivery engines and processors to be selected or varied to fit the needs of a particular application.

The configuration of the content delivery system described above provides scalability without having to scale all the resources of a system. Thus, unlike the traditional rack and stack systems, such as server systems in which an entire server may be added just to expand one segment of system resources, the content delivery system allows the particular resources needed to be the only expanded resources. For example, storage resources may be greatly expanded without having to expand all of the traditional server resources.

Distributive Interconnect

Still referring to FIG. 1A, distributive interconnection 1080 may be any multi-node I/O interconnection hardware or hardware/software system suitable for distributing functionality by selectively interconnecting two or more content delivery engines of a content delivery system including, but not limited to, high speed interchange systems such as a switch fabric or bus architecture. Examples of switch fabric architectures include cross-bar switch fabrics, Ethernet switch fabrics, ATM switch fabrics, etc. Examples of bus architectures include PCI, PCI-X, SBus, Microchannel, VME, etc. Generally, for purposes of this description, a “bus” is any system bus that carries data in a manner that is visible to all nodes on the bus. Generally, some sort of bus arbitration scheme is implemented and data may be carried in parallel, as n-bit words. As distinguished from a bus, a switch fabric establishes independent paths from node to node and data is specifically addressed to a particular node on the switch fabric. Other nodes do not see the data nor are they blocked from creating their own paths. The result is a simultaneous guaranteed bit rate in each direction for each of the switch fabric's ports.

The use of a distributed interconnect 1080 to connect the various processing engines in lieu of the network connections used with the switches of conventional multi-server endpoints is beneficial for several reasons. As compared to network connections, the distributed interconnect 1080 is less error prone, allows more deterministic content delivery, and provides higher bandwidth connections to the various processing engines. The distributed interconnect 1080 also has greatly improved data integrity and throughput rates as compared to network connections.

Use of the distributed interconnect 1080 allows latency between content delivery engines to be short, finite and follow a known path. Known maximum latency specifications are typically associated with the various bus architectures listed above. Thus, when the employed interconnect medium is a bus, latencies fall within a known range. In the case of a switch fabric, latencies are fixed. Further, the connections are “direct”, rather than by some undetermined path. In general, the use of the distributed interconnect 1080 rather than network connections, permits the switching and interconnect capacities of the content delivery system 1010 to be predictable and consistent.

One example interconnection system suitable for use as distributive interconnection 1080 is an 8/16 port 28.4 Gbps high speed PRIZMA-E non-blocking switch fabric switch available from IBM. It will be understood that other switch fabric configurations having greater or lesser numbers of ports, throughput, and capacity are also possible. Among the advantages offered by such a switch fabric interconnection in comparison to shared-bus interface interconnection technology are throughput, scalability and fast and efficient communication between individual discrete content delivery engines of content delivery system 1010. In the embodiment of FIG. 1A, distributive interconnection 1080 facilitates parallel and independent operation of each engine in its own optimized environment without bandwidth interference from other engines, while at the same time providing peer-to-peer communication between the engines on an asneeded basis (e.g., allowing direct communication between any two content delivery engines 1030, 1040, 1050, 1060 and 1070). Moreover, the distributed interconnect may directly transfer inter-processor communications between the various engines of the system. Thus, communication, command and control information may be provided between the various peers via the distributed interconnect. In addition, communication from one peer to multiple peers may be implemented through a broadcast communication which is provided from one peer to all peers coupled to the interconnect. The interface for each peer may be standardized, thus providing ease of design and allowing for system scaling by providing standardized ports for adding additional peers.

Network Interface Processing Engine

As illustrated in FIG. 1A, network interface processing engine 1030 interfaces with network 1020 by receiving and processing requests for content and delivering requested content to network 1020. Network interface processing engine 1030 may be any hardware or hardware/software subsystem suitable for connections utilizing TCP (Transmission Control Protocol) IP (Internet Protocol), UDP (User Datagram Protocol), RTP (Real-Time Transport Protocol), Internet Protocol (IP), Wireless Application Protocol (WAP) as well as other networking protocols. Thus the network interface processing engine 1030 may be suitable for handling queue management, buffer management, TCP connect sequence, checksum, IP address lookup, internal load balancing, packet switching, etc. Thus, network interface processing engine 1030 may be employed as illustrated to process or terminate one or more layers of the network protocol stack and to perform look-up intensive operations, offloading these tasks from other content delivery processing engines of content delivery system 1010. Network interface processing engine 1030 may also be employed to load balance among other content delivery processing engines of content delivery system 1010. Both of these features serve to accelerate content delivery, and are enhanced by placement of distributive interchange and protocol termination processing functions on the same board. Examples of other functions that may be performed by network interface processing engine 1030 include, but are not limited to, security processing.

With regard to the network protocol stack, the stack in traditional systems may often be rather large. Processing the entire stack for every request across the distributed interconnect may significantly impact performance. As described herein, the protocol stack has been segmented or “split” between the network interface engine and the transport processing engine. An abbreviated version of the protocol stack is then provided across the interconnect. By utilizing this functionally split version of the protocol stack, increased bandwidth may be obtained. In this manner the communication and data flow through the content delivery system 1010 may be accelerated. The use of a distributed interconnect (for example a switch fabric) further enhances this acceleration as compared to traditional bus interconnects.

The network interface processing engine 1030 may be coupled to the network 1020 through a Gigabit (Gb) Ethernet fiber front end interface 1022. One or more additional Gb Ethernet interfaces 1023 may optionally be provided, for example, to form a second interface with network 1020, or to form an interface with a second network or application 1024 as shown (e.g., to form an interface with one or more server/s for delivery of web cache content, etc.). Regardless of whether the network connection is via Ethernet, or some other means, the network connection could be of any type, with other examples being ATM, SONET, or wireless. The physical medium between the network and the network processor may be copper, optical fiber, wireless, etc.

In one embodiment, network interface processing engine 1030 may utilize a network processor, although it will be understood that in other embodiments a network processor may be supplemented with or replaced by a general purpose processor or an embedded microcontroller. The network processor may be one of the various types of specialized processors that have been designed and marketed to switch network traffic at intermediate nodes. Consistent with this conventional application, these processors are designed to process high speed streams of network packets. In conventional operation, a network processor receives a packet from a port, verifies fields in the packet header, and decides on an outgoing port to which it forwards the packet. The processing of a network processor may be considered as “pass through” processing, as compared to the intensive state modification processing performed by general purpose processors. A typical network processor has a number of processing elements, some operating in parallel and some in pipeline. Often a characteristic of a network processor is that it may hide memory access latency needed to perform lookups and modifications of packet header fields. A network processor may also have one or more network interface controllers, such as a gigabit Ethernet controller, and are generally capable of handling data rates at “wire speeds”.

Examples of network processors include the C-Port processor manufactured by Motorola, Inc., the IXP1200 processor manufactured by Intel Corporation, the Prism processor manufactured by SiTera Inc., and others manufactured by MMC Networks, Inc. and Agere, Inc. These processors are programmable, usually with a RISC or augmented RISC instruction set, and are typically fabricated on a single chip.

The processing cores of a network processor are typically accompanied by special purpose cores that perform specific tasks, such as fabric interfacing, table lookup, queue management, and buffer management. Network processors typically have their memory management optimized for data movement, and have multiple I/O and memory buses. The programming capability of network processors permit them to be programmed for a variety of tasks, such as load balancing, network protocol processing, network security policies, and QoS/CoS support. These tasks can be tasks that would otherwise be performed by another processor. For example, TCP/IP processing may be performed by a network processor at the front end of an endpoint system. Another type of processing that could be offloaded is execution of network security policies or protocols. A network processor could also be used for load balancing. Network processors used in this manner can be referred to as “network accelerators” because their front end “look ahead” processing can vastly increase network response speeds. Network processors perform look ahead processing by operating at the front end of the network endpoint to process network packets in order to reduce the workload placed upon the remaining endpoint resources. Various uses of network accelerators are described in the following concurrently filed U.S. patent application Ser. No. ______, entitled “Network Transport Accelerator,” by Bailey et. al; and Ser. No. ______ entitled “Network Security Accelerator,” by Canion et. al; the disclosures of which are all incorporated herein by reference. When utilizing network processors in an endpoint environment it may be advantageous to utilize techniques for order serialization of information, such as for example, as disclosed in concurrently filed U.S. patent application Ser. No. ______, entitled “Methods and Systems For The Order Serialization Of Information In A Network Processing Environment,” by Richter et. al, the disclosure of which is incorporated herein by reference. 30

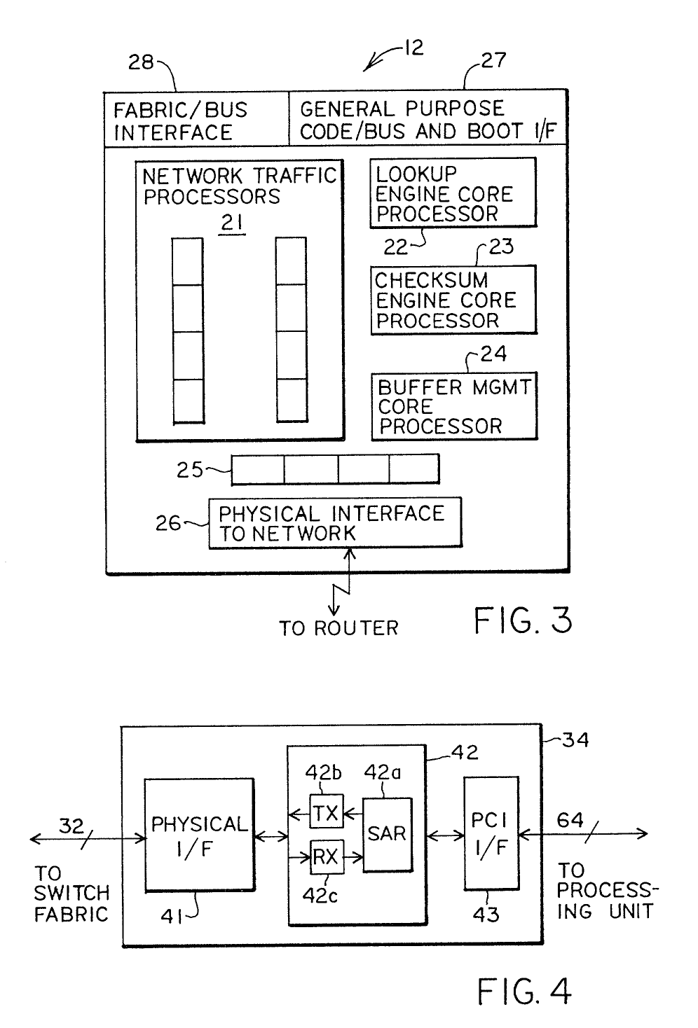

FIG. 3 illustrates one possible general configuration of a network processor. As illustrated, a set of traffic processors 21 operate in parallel to handle transmission and receipt of network traffic. These processors may be general purpose microprocessors or state machines. Various core processors 22-24 handle special tasks. For example, the core processors 22-24 may handle lookups, checksums, and buffer management. A set of serial data processors 25 provide Layer 1 network support. Interface 26 provides the physical interface to the network 1020. A general purpose bus interface 27 is used for downloading code and configuration tasks. A specialized interface 28 may be specially programmed to optimize the path between network processor 12 and distributed interconnection 1080.

As mentioned above, the network processors utilized in the content delivery system 1010 are utilized for endpoint use, rather than conventional use at intermediate network nodes. In one embodiment, network interface processing engine 1030 may utilize a MOTOROLA C-Port C-5 network processor capable of handling two Gb Ethernet interfaces at wire speed, and optimized for cell and packet processing. This network processor may contain sixteen 200 MHz MIPS processors for cell/packet switching and thirty-two serial processing engines for bit/byte processing, checksum generation/verification, etc. Further processing capability may be provided by five co-processors that perform the following network specific tasks: supervisor/executive, switch fabric interface, optimized table lookup, queue management, and buffer management. The network processor may be coupled to the network 1020 by using a VITESSE GbE SERDES (serializer-deserializer) device (for example the VSC7123) and an SFP (small form factor pluggable) optical transceiver for LC fiber connection.

Transport/Protocol Processing Engine

Referring again to FIG. 1A, transport processing engine 1050 may be provided for performing network transport protocol sub-tasks, such as processing content requests received from network interface engine 1030. Although named a “transport” engine for discussion purposes, it will be recognized that the engine 1050 performs transport and protocol processing and the term transport processing engine is not meant to limit the functionality of the engine. In this regard transport processing engine 1050 may be any hardware or hardware/software subsystem suitable for TCP/UDP processing, other protocol processing, transport processing, etc. In one embodiment transport engine 1050 may be a dedicated TCP/UDP processing module based on an INTEL PENTIUM III or MOTOROLA POWERPC 7450 based processor running the Thread-X RTOS environment with protocol stack based on TCP/IP technology.

As compared to traditional server type computing systems, the transport processing engine 1050 may off-load other tasks that traditionally a main CPU may perform. For example, the performance of server CPUs significantly decreases when a large amount of network connections are made merely because the server CPU regularly checks each connection for time outs. The transport processing engine 1050 may perform time out checks for each network connection, session management, data reordering and retransmission, data queueing and flow control, packet header generation, etc. off-loading these tasks from the application processing engine or the network interface processing engine. The transport processing engine 1050 may also handle error checking, likewise freeing up the resources of other processing engines.

Network Interface/Transport Split Protocol

The embodiment of FIG. 1A contemplates that the protocol processing is shared between the transport processing engine 1050 and the network interface engine 1030. This sharing technique may be called “split protocol stack” processing. The division of tasks may be such that higher tasks in the protocol stack are assigned to the transport processor engine. For example, network interface engine 1030 may processes all or some of the TCP/IP protocol stack as well as all protocols lower on the network protocol stack. Another approach could be to assign state modification intensive tasks to the transport processing engine.

In one embodiment related to a content delivery system that receives packets, the network interface engine performs the MAC header identification and verification, IP header identification and verification, IP header checksum validation, TCP and UDP header identification and validation, and TCP or UDP checksum validation. It also may perform the lookup to determine the TCP connection or UDP socket (protocol session identifier) to which a received packet belongs. Thus, the network interface engine verifies packet lengths, checksums, and validity. For transmission of packets, the network interface engine performs TCP or UDP checksum generation, IP header generation, and MAC header generation, IP checksum generation, MAC FCS/CRC generation, etc.

Tasks such as those described above can all be performed rapidly by the parallel and pipeline processors within a network processor. The “fly by” processing style of a network processor permits it to look at each byte of a packet as it passes through, using registers and other alternatives to memory access. The network processor's “stateless forwarding” operation is best suited for tasks not involving complex calculations that require rapid updating of state information.

An appropriate internal protocol may be provided for exchanging information between the network interface engine 1030 and the transport engine 1050 when setting up or terminating a TCP and/or UDP connections and to transfer packets between the two engines. For example, where the distributive interconnection medium is a switch fabric, the internal protocol may be implemented as a set of messages exchanged across the switch fabric. These messages indicate the arrival of new inbound or outbound connections and contain inbound or outbound packets on existing connections, along with identifiers or tags for those connections. The internal protocol may also be used to transfer identifiers or tags between the transport engine 1050 and the application processing engine 1070 and/or the storage processing engine 1040. These identifiers or tags may be used to reduce or strip or accelerate a portion of the protocol stack.

For example, with a TCP/IP connection, the network interface engine 1030 may receive a request for a new connection. The header information associated with the initial request may be provided to the transport processing engine 1050 for processing. That result of this processing may be stored in the resources of the transport processing engine 1050 as state and management information for that particular network session. The transport processing engine 1050 then informs the network interface engine 1030 as to the location of these results. Subsequent packets related to that connection that are processed by the network interface engine 1030 may have some of the header information stripped and replaced with an identifier or tag that is provided to the transport processing engine 1050. The identifier or tag may be a pointer, index or any other mechanism that provides for the identification of the location in the transport processing engine of the previously setup state and management information (or the corresponding network session). In this manner, the transport processing engine 1050 does not have to process the header information of every packet of a connection. Rather, the transport interface engine merely receives a contextually meaningful identifier or tag that identifies the previous processing results for that connection.

In one embodiment, the data link, network, transport and session layers (layers 2-5) of a packet may be replaced by identifier or tag information. For packets related to an established connection the transport processing engine does not have to perform intensive processing with regard to these layers such as hashing, scanning, look up, etc. operations. Rather, these layers have already been converted (or processed) once in the transport processing engine and the transport processing engine just receives the identifier or tag provided from the network interface engine that identifies the location of the conversion results.

In this manner an identifier or tag is provided for each packet of an established connection so that the more complex data computations of converting header information may be replaced with a more simplistic analysis of an identifier or tag. The delivery of content is thereby accelerated, as the time for packet processing and the amount of system resources for packet processing are both reduced. The functionality of network processors, which provide efficient parallel processing of packet headers, is well suited for enabling the acceleration described herein. In addition, acceleration is further provided as the physical size of the packets provided across the distributed interconnect may be reduced.

Though described herein with reference to messaging between the network interface engine and the transport processing engine, the use of identifiers or tags may be utilized amongst all the engines in the modular pipelined processing described herein. Thus, one engine may replace packet or data information with contextually meaningful information that may require less processing by the next engine in the data and communication flow path. In addition, these techniques may be utilized for a wide variety of protocols and layers, not just the exemplary embodiments provided herein.

With the above-described tasks being performed by the network interface engine, the transport engine may perform TCP sequence number processing, acknowledgement and retransmission, segmentation and reassembly, and flow control tasks. These tasks generally call for storing and modifying connection state information on each TCP and UDP connection, and therefore are considered more appropriate for the processing capabilities of general purpose processors.

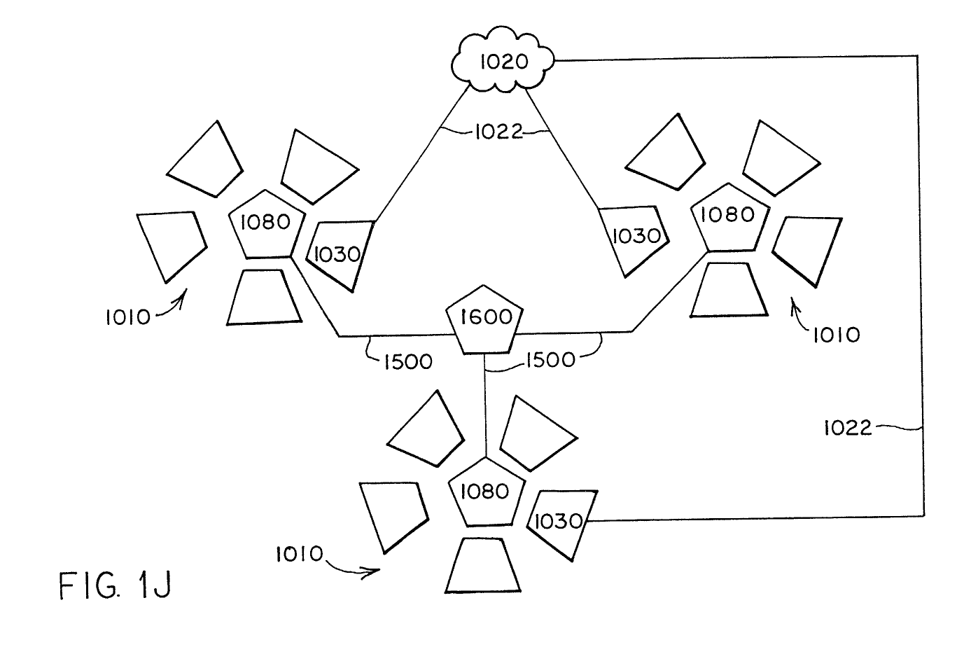

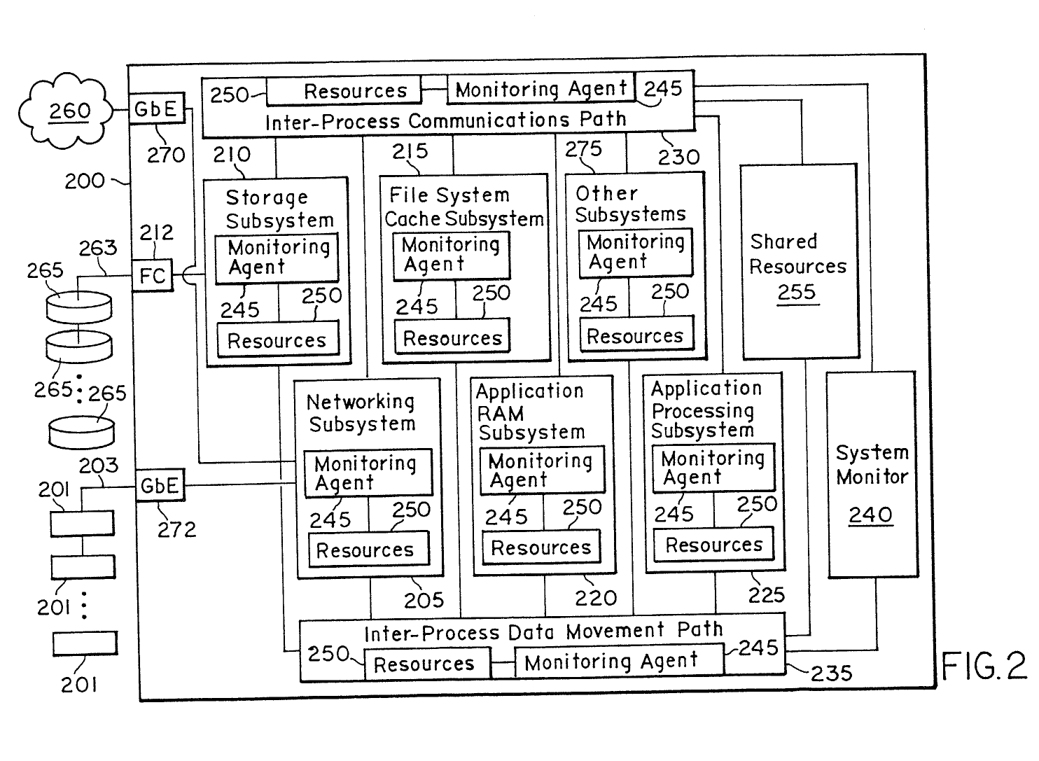

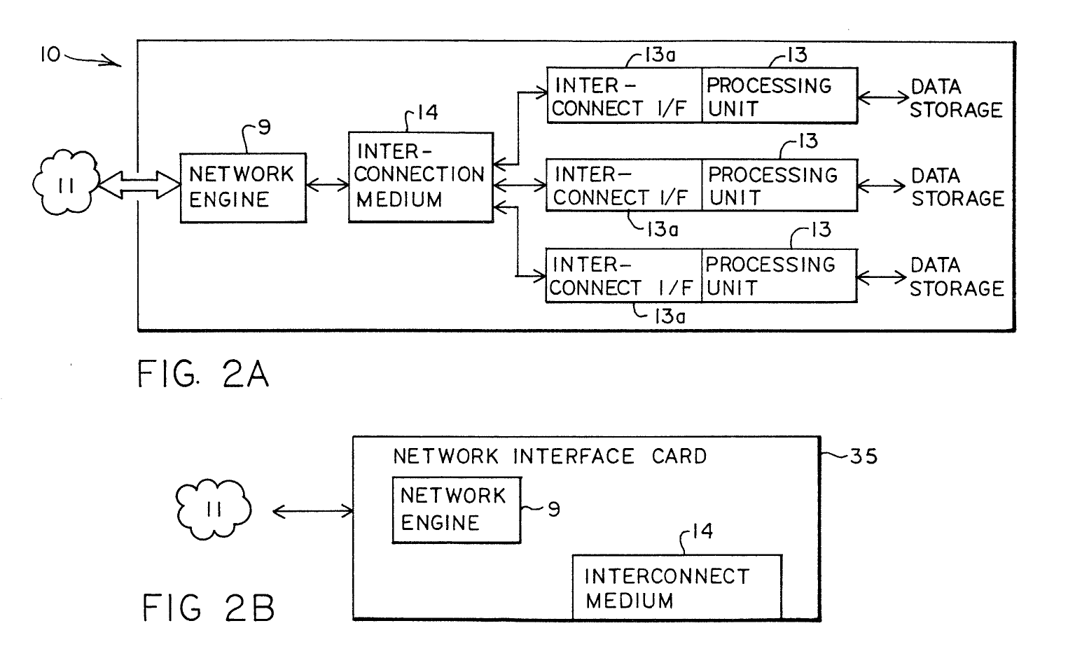

As will be discussed with references to alternative embodiments (such as FIGS. 2 and 2A), the transport engine 1050 and the network interface engine 1030 may be combined into a single engine. Such a combination may be advantageous as communication across the switch fabric is not necessary for protocol processing. However, limitations of many commercially available network processors make the split protocol stack processing described above desirable.

Application Processing Engine

Application processing engine 1070 may be provided in content delivery system 1010 for application processing, and may be, for example, any hardware or hardware/software subsystem suitable for session layer protocol processing (e.g., HTTP, RTSP streaming, etc.) of content requests received from network transport processing engine 1050. In one embodiment application processing engine 1070 may be a dedicated application processing module based on an INTEL PENTIUM III processor running, for example, on standard x86 OS systems (e.g., Linux, Windows NT, FreeBSD, etc.). Application processing engine 1070 may be utilized for dedicated application-only processing by virtue of the off-loading of all network protocol and storage processing elsewhere in content delivery system 1010. In one embodiment, processor programming for application processing engine 1070 may be generally similar to that of a conventional server, but without the tasks off-loaded to network interface processing engine 1030, storage processing engine 1040, and transport processing engine 1050.

Storage Management Engine

Storage management engine 1040 may be any hardware or hardware/software subsystem suitable for effecting delivery of requested content from content sources (for example content sources 1090 and/or 1100) in response to processed requests received from application processing engine 1070. It will also be understood that in various embodiments a storage management engine 1040 may be employed with content sources other than disk drives (e.g., solid state storage, the storage systems described above, or any other media suitable for storage of data) and may be programmed to request and receive data from these other types of storage.

In one embodiment, processor programming for storage management engine 1040 may be optimized for data retrieval using techniques such as caching, and may include and maintain a disk cache to reduce the relatively long time often required to retrieve data from content sources, such as disk drives. Requests received by storage management engine 1040 from application processing engine 1070 may contain information on how requested data is to be formatted and its destination, with this information being comprehensible to transport processing engine 1050 and/or network interface processing engine 1030. The storage management engine 1040 may utilize a disk cache to reduce the relatively long time it may take to retrieve data stored in a storage medium such as disk drives. Upon receiving a request, storage management engine 1040 may be programmed to first determine whether the requested data is cached, and then to send a request for data to the appropriate content source 1090 or 1100. Such a request may be in the form of a conventional read request. The designated content source 1090 or 1100 responds by sending the requested content to storage management engine 1040, which in turn sends the content to transport processing engine 1050 for forwarding to network interface processing engine 1030.

Based on the data contained in the request received from application processing engine 1070, storage processing engine 1040 sends the requested content in proper format with the proper destination data included. Direct communication between storage processing engine 1040 and transport processing engine 1050 enables application processing engine 1070 to be bypassed with the requested content. Storage processing engine 1040 may also be configured to write data to content sources 1090 and/or 1100 (e.g., for storage of live or broadcast streaming content).

In one embodiment storage management engine 1040 may be a dedicated block-level cache processor capable of block level cache processing in support of thousands of concurrent multiple readers, and direct block data switching to network interface engine 1030. In this regard storage management engine 1040 may utilize a POWER PC 7450 processor in conjunction with ECC memory and a LSI SYMFC929 dual 2 GBaud fibre channel controller for fibre channel interconnect to content sources 1090 and/or 1100 via dual fibre channel arbitrated loop 1092. It will be recognized, however, that other forms of interconnection to storage sources suitable for retrieving content are also possible. Storage management engine 1040 may include hardware and/or software for running the Fibre Channel (FC) protocol, the SCSI (Small Computer Systems Interface) protocol, iSCSI protocol as well as other storage networking protocols.

Storage management engine 1040 may employ any suitable method for caching data, including simple computational caching algorithms such as random removal (RR), first-in first-out (FIFO), predictive read-ahead, over buffering, etc. algorithms. Other suitable caching algorithms include those that consider one or more factors in the manipulation of content stored within the cache memory, or which employ multi-level ordering, key based ordering or function based calculation for replacement. In one embodiment, storage management engine may implement a layered multiple LRU (LMLRU) algorithm that uses an integrated block/buffer management structure including at least two layers of a configurable number of multiple LRU queues and a two-dimensional positioning algorithm for data blocks in the memory to reflect the relative priorities of a data block in the memory in terms of both recency and frequency. Such a caching algorithm is described in further detail in concurrently filed U.S. patent application Ser. No. ______, entitled “Systems and Methods for Management of Memory” by Qiu et. al, the disclosure of which is incorporated herein by reference.

For increasing delivery efficiency of continuous content, such as streaming multimedia content, storage management engine 1040 may employ caching algorithms that consider the dynamic characteristics of continuous content. Suitable examples include, but are not limited to, interval caching algorithms. In one embodiment, improved caching performance of continuous content may be achieved using an LMLRU caching algorithm that weighs ongoing viewer cache value versus the dynamic time-size cost of maintaining particular content in cache memory. Such a caching algorithm is described in further detail in concurrently filed U.S. patent application Ser. No. ______, entitled “Systems and Methods for Management of Memory in Information Delivery Environments” by Qiu et. al, the disclosure of which is incorporated herein by reference.

System Management Engine

System management (or host) engine 1060 may be present to perform system management functions related to the operation of content delivery system 1010. Examples of system management functions include, but are not limited to, content provisioning/updates, comprehensive statistical data gathering and logging for sub-system engines, collection of shared user bandwidth utilization and content utilization data that may be input into billing and accounting systems, “on the fly” ad insertion into delivered content, customer programmable sub-system level quality of service (“QoS”) parameters, remote management (e.g., SNMP, web-based, CLI), health monitoring, clustering controls, remote/local disaster recovery functions, predictive performance and capacity planning, etc. In one embodiment, content delivery bandwidth utilization by individual content suppliers or users (e.g. individual supplier/user usage of distributive interchange and/or content delivery engines) may be tracked and logged by system management engine 1060, enabling an operator of the content delivery system 1010 to charge each content supplier or user on the basis of content volume delivered.

System management engine 1060 may be any hardware or hardware/software subsystem suitable for performance of one or more such system management engines and in one embodiment may be a dedicated application processing module based, for example, on an INTEL PENTIUM III processor running an x86 OS. Because system management engine 1060 is provided as a discrete modular engine, it may be employed to perform system management functions from within content delivery system 1010 without adversely affecting the performance of the system. Furthermore, the system management engine 1060 may maintain information on processing engine assignment and content delivery paths for various content delivery applications, substantially eliminating the need for an individual processing engine to have intimate knowledge of the hardware it intends to employ.

Under manual or scheduled direction by a user, system management processing engine 1060 may retrieve content from the network 1020 or from one or more external servers on a second network 1024 (e.g., LAN) using, for example, network file system (NFS) or common internet file system (CIFS) file sharing protocol. Once content is retrieved, the content delivery system may advantageously maintain an independent copy of the original content, and therefore is free to employ any file system structure that is beneficial, and need not understand low level disk formats of a large number of file systems.

Management interface 1062 may be provided for interconnecting system management engine 1060 with a network 1200 (e.g., LAN), or connecting content delivery system 1010 to other network appliances such as other content delivery systems 1010, servers, computers, etc. Management interface 1062 may be by any suitable network interface, such as 10/100 Ethernet, and may support communications such as management and origin traffic. Provision for one or more terminal management interfaces (not shown) for may also be provided, such as by RS-232 port, etc. The management interface may be utilized as a secure port to provide system management and control information to the content delivery system 1010. For example, tasks which may be accomplished through the management interface 1062 include reconfiguration of the allocation of system hardware (as discussed below with reference to FIGS. 1C-1F), programming the application processing engine, diagnostic testing, and any other management or control tasks. Though generally content is not envisioned being provided through the management interface, the identification of or location of files or systems containing content may be received through the management interface 1062 so that the content delivery system may access the content through the other higher bandwidth interfaces.

Management Performed By The Network Inteface

Some of the system management functionality may also be performed directly within the network interface processing engine 1030. In this case some system policies and filters may be executed by the network interface engine 1030 in real-time at wirespeed. These polices and filters may manage some traffic/bandwidth management criteria and various service level guarantee policies. Examples of such system management functionality of are described below. It will be recognized that these functions may be performed by the system management engine 1060, the network interface engine 1030, or a combination thereof.

For example, a content delivery system may contain data for two web sites. An operator of the content delivery system may guarantee one web site (“the higher quality site”) higher performance or bandwidth than the other web site (“the lower quality site”), presumably in exchange for increased compensation from the higher quality site. The network interface processing engine 1030 may be utilized to determine if the bandwidth limits for the lower quality site have been exceeded and reject additional data requests related to the lower quality site. Alternatively, requests related to the lower quality site may be rejected to ensure the guaranteed performance of the higher quality site is achieved. In this manner the requests may be rejected immediately at the interface to the external network and additional resources of the content delivery system need not be utilized. In another example, storage service providers may use the content delivery system to charge content providers based on system bandwidth of downloads (as opposed to the traditional storage area based fees). For billing purposes, the network interface engine may monitor the bandwidth use related to a content provider. The network interface engine may also reject additional requests related to content from a content provider whose bandwidth limits have been exceeded. Again, in this manner the requests may be rejected immediately at the interface to the external network and additional resources of the content delivery system need not be utilized.

Additional system management functionality, such as quality of service (QoS) functionality, also may be performed by the network interface engine. A request from the external network to the content delivery system may seek a specific file and also may contain Quality of Service (QoS) parameters. In one example, the QoS parameter may indicate the priority of service that a client on the external network is to receive. The network interface engine may recognize the QoS data and the data may then be utilized when managing the data and communication flow through the content delivery system. The request may be transferred to the storage management engine to access this file via a read queue, e.g., [Destination IP][Filename][File Type (CoS)][Transport Priorities (QoS)]. All file read requests may be stored in a read queue. Based on CoS/QoS policy parameters as well as buffer status within the storage management engine (empty, full, near empty, block seq#, etc), the storage management engine may prioritize which blocks of which files to access from the disk next, and transfer this data into the buffer memory location that has been assigned to be transmitted to a specific IP address. Thus based upon QoS data in the request provided to the content delivery system, the data and communication traffic through the system may be prioritized. The QoS and other policy priorities may be applied to both incoming and outgoing traffic flow. Therefore a request having a higher QoS priority may be received after a lower order priority request, yet the higher priority request may be served data before the lower priority request.

The network interface engine may also be used to filter requests that are not supported by the content delivery system. For example, if a content delivery system is configured only to accept HTTP requests, then other requests such as FTP, telnet, etc. may be rejected or filtered. This filtering may be applied directly at the network interface engine, for example by programming a network processor with the appropriate system policies. Limiting undesirable traffic directly at the network interface offloads such functions from the other processing modules and improves system performance by limiting the consumption of system resources by the undesirable traffic. It will be recognized that the filtering example described herein is merely exemplary and many other filter criteria or policies may be provided.

Multi-Processor Module Design

As illustrated in FIG. 1A, any given processing engine of content delivery system 1010 may be optionally provided with multiple processing modules so as to enable parallel or redundant processing of data and/or communications. For example, two or more individual dedicated TCP/UDP processing modules 1050a and 1050b may be provided for transport processing engine 1050, two or more individual application processing modules 1070a and 1070b may be provided for network application processing engine 1070, two or more individual network interface processing modules 1030a and 1030b may be provided for network interface processing engine 1030 and two or more individual storage management processing modules 1040a and 1040b may be provided for storage management processing engine 1040. Using such a configuration, a first content request may be processed between a first TCP/UDP processing module and a first application processing module via a first switch fabric path, at the same time a second content request is processed between a second TCP/UDP processing module and a second application processing module via a second switch fabric path. Such parallel processing capability may be employed to accelerate content delivery.

Alternatively, or in combination with parallel processing capability, a first TCP/UDP processing module 1050a may be backed-up by a second TCP/UDP processing module 1050b that acts as an automatic failover spare to the first module 1050a. In those embodiments employing multiple-port switch fabrics, various combinations of multiple modules may be selected for use as desired on an individual system-need basis (e.g., as may be dictated by module failures and/or by anticipated or actual bottlenecks), limited only by the number of available ports in the fabric. This feature offers great flexibility in the operation of individual engines and discrete processing modules of a content delivery system, which may be translated into increased content delivery acceleration and reduction or substantial elimination of adverse effects resulting from system component failures.

In yet other embodiments, the processing modules may be specialized to specific applications, for example, for processing and delivering HTTP content, processing and delivering RTSP content, or other applications. For example, in such an embodiment an application processing module 1070a and storage processing module 1050a may be specially programmed for processing a first type of request received from a network. In the same system, application processing module 1070b and storage processing module 1050b may be specially programmed to handle a second type of request different from the first type. Routing of requests to the appropriate respective application and/or storage modules may be accomplished using a distributive interconnect and may be controlled by transport and/or interface processing modules as requests are received and processed by these modules using policies set by the system management engine.

Further, by employing processing modules capable of performing the function of more than one engine in a content delivery system, the assigned functionality of a given module may be changed on an as-needed basis, either manually or automatically by the system management engine upon the occurrence of given parameters or conditions. This feature may be achieved, for example, by using similar hardware modules for different content delivery engines (e.g., by employing PENTIUM III based processors for both network transport processing modules and for application processing modules), or by using different hardware modules capable of performing the same task as another module through software programmability (e.g., by employing a POWER PC processor based module for storage management modules that are also capable of functioning as network transport modules). In this regard, a content delivery system may be configured so that such functionality reassignments may occur during system operation, at system boot-up or in both cases. Such reassignments may be effected, for example, using software so that in a given content delivery system every content delivery engine (or at a lower level, every discrete content delivery processing module) is potentially dynamically reconfigurable using software commands. Benefits of engine or module reassignment include maximizing use of hardware resources to deliver content while minimizing the need to add expensive hardware to a content delivery system.

Thus, the system disclosed herein allows various levels of load balancing to satisfy a work request. At a system hardware level, the functionality of the hardware may be assigned in a manner that optimizes the system performance for a given load. At the processing engine level, loads may be balanced between the multiple processing modules of a given processing engine to further optimize the system performance.

Clusters of Systems

The systems described herein may also be clustered together in groups of two or more to provide additional processing power, storage connections, bandwidth, etc. Communication between two individual systems each configured similar to content delivery system 1010 may be made through network interface 1022 and/or 1023. Thus, one content delivery system could communicate with another content delivery system through the network 1020 and/or 1024. For example, a storage unit in one content delivery system could send data to a network interface engine of another content delivery system. As an example, these communications could be via TCP/IP protocols. Alternatively, the distributed interconnects 1080 of two content delivery systems 1010 may communicate directly. For example, a connection may be made directly between two switch fabrics, each switch fabric being the distributed interconnect 1080 of separate content delivery systems 1010.

FIGS. 1G-1J illustrate four exemplary clusters of content delivery systems 1010. It will be recognized that many other cluster arrangements may be utilized including more or less content delivery systems. As shown in FIGS. 1G-1J, each content delivery system may be configured as described above and include a distributive interconnect 1080 and a network interface processing engine 1030. Interfaces 1022 may connect the systems to a network 1020. As shown in FIG. 1G, two content delivery systems may be coupled together through the interface 1023 that is connected to each system's network interface processing engine 1030. FIG. 1H shows three systems coupled together as in FIG. 1G. The interfaces 1023 of each system may be coupled directly together as shown, may be coupled together through a network or may be coupled through a distributed interconnect (for example a switch fabric).

FIG. 11 illustrates a cluster in which the distributed interconnects 1080 of two systems are directly coupled together through an interface 1500. Interface 1500 may be any communication connection, such as a copper connection, optical fiber, wireless connection, etc. Thus, the distributed interconnects of two or more systems may directly communicate without communication through the processor engines of the content delivery systems 1010. FIG. 1J illustrates the distributed interconnects of three systems directly communicating without first requiring communication through the processor engines of the content delivery systems 1010. As shown in FIG. 1J, the interfaces 1500 each communicate with each other through another distributed interconnect 1600. Distributed interconnect 1600 may be a switched fabric or any other distributed interconnect.

The clustering techniques described herein may also be implemented through the use of the management interface 1062. Thus, communication between multiple content delivery systems 1010 also may be achieved through the management interface 1062

Exemplary Data and Communication Flow Paths

FIG. 1B illustrates one exemplary data and communication flow path configuration among modules of one embodiment of content delivery system 1010. The flow paths shown in FIG. 1B are just one example given to illustrate the significant improvements in data processing capacity and content delivery acceleration that may be realized using multiple content delivery engines that are individually optimized for different layers of the software stack and that are distributively interconnected as disclosed herein. The illustrated embodiment of FIG. 1B employs two network application processing modules 1070a and 1070b, and two network transport processing modules 1050a and 1050b that are communicatively coupled with single storage management processing module 1040a and single network interface processing module 1030a. The storage management processing module 1040a is in turn coupled to content sources 1090 and 1100. In FIG. 1B, inter-processor command or control flow (i.e. incoming or received data request) is represented by dashed lines, and delivered content data flow is represented by solid lines. Command and data flow between modules may be accomplished through the distributive interconnection 1080 (not shown), for example a switch fabric.

As shown in FIG. 1B, a request for content is received and processed by network interface processing module 1030a and then passed on to either of network transport processing modules 1050a or 1050b for TCP/UDP processing, and then on to respective application processing modules 1070a or 1070b, depending on the transport processing module initially selected. After processing by the appropriate network application processing module, the request is passed on to storage management processor 1040a for processing and retrieval of the requested content from appropriate content sources 1090 and/or 1100. Storage management processing module 1040a then forwards the requested content directly to one of network transport processing modules 1050a or 1050b, utilizing the capability of distributive interconnection 1080 to bypass network application processing modules 1070a and 1070b. The requested content may then be transferred via the network interface processing module 1030a to the external network 1020. Benefits of bypassing the application processing modules with the delivered content include accelerated delivery of the requested content and offloading of workload from the application processing modules, each of which translate into greater processing efficiency and content delivery throughput. In this regard, throughput is generally measured in sustained data rates passed through the system and may be measured in bits per second. Capacity may be measured in terms of the number of files that may be partially cached, the number of TCP/IP connections per second as well as the number of concurrent TCP/IP connections that may be maintained or the number of simultaneous streams of a certain bit rate. In an alternative embodiment, the content may be delivered from the storage management processing module to the application processing module rather than bypassing the application processing module. This data flow may be advantageous if additional processing of the data is desired. For example, it may be desirable to decode or encode the data prior to delivery to the network.

To implement the desired command and content flow paths between multiple modules, each module may be provided with means for identification, such as a component ID. Components may be affiliated with content requests and content delivery to effect a desired module routing. The data-request generated by the network interface engine may include pertinent information such as the component ID of the various modules to be utilized in processing the request. For example, included in the data request sent to the storage management engine may be the component ID of the transport engine that is designated to receive the requested content data. When the storage management engine retrieves the data from the storage device and is ready to send the data to the next engine, the storage management engine knows which component ID to send the data to.

As further illustrated in FIG. 1B, the use of two network transport modules in conjunction with two network application processing modules provides two parallel processing paths for network transport and network application processing, allowing simultaneous processing of separate content requests and simultaneous delivery of separate content through the parallel processing paths, further increasing throughput/capacity and accelerating content delivery. Any two modules of a given engine may communicate with separate modules of another engine or may communicate with the same module of another engine. This is illustrated in FIG. 1B where the transport modules are shown to communicate with separate application modules and the application modules are shown to communicate with the same storage management module.

FIG. 1B illustrates only one exemplary embodiment of module and processing flow path configurations that may be employed using the disclosed method and system. Besides the embodiment illustrated in FIG. 1B, it will be understood that multiple modules may be additionally or alternatively employed for one or more other network content delivery engines (e.g., storage management processing engine, network interface processing engine, system management processing engine, etc.) to create other additional or alternative parallel processing flow paths, and that any number of modules (e.g., greater than two) may be employed for a given processing engine or set of processing engines so as to achieve more than two parallel processing flow paths. For example, in other possible embodiments, two or more different network transport processing engines may pass content requests to the same application unit, or vice-versa.

Thus, in addition to the processing flow paths illustrated in FIG. 1B, it will be understood that the disclosed distributive interconnection system may be employed to create other custom or optimized processing flow paths (e.g., by bypassing and/or interconnecting any given number of processing engines in desired sequence/s) to fit the requirements or desired operability of a given content delivery application. For example, the content flow path of FIG. 1B illustrates an exemplary application in which the content is contained in content sources 1090 and/or 1100 that are coupled to the storage processing engine 1040. However as discussed above with reference to FIG. 1A, remote and/or live broadcast content may be provided to the content delivery system from the networks 1020 and/or 1024 via the second network interface connection 1023. In such a situation the content may be received by the network interface engine 1030 over interface connection 1023 and immediately re-broadcast over interface connection 1022 to the network 1020. Alternatively, content may be proceed through the network interface connection 1023 to the network transport engine 1050 prior to returning to the network interface engine 1030 for rebroadcast over interface connection 1022 to the network 1020 or 1024. In yet another alternative, if the content requires some manner of application processing (for example encoded content that may need to be decoded), the content may proceed all the way to the application engine 1070 for processing. After application processing the content may then be delivered through the network transport engine 1050, network interface engine 1030 to the network 1020 or 1024.

In yet another embodiment, at least two network interface modules 1030a and 1030b may be provided, as illustrated in FIG. 1A. In this embodiment, a first network interface engine 1030a may receive incoming data from a network and pass the data directly to the second network interface engine 1030b for transport back out to the same or different network. For example, in the remote or live broadcast application described above, first network interface engine 1030a may receive content, and second network interface engine 1030b provide the content to the network 1020 to fulfill requests from one or more clients for this content. Peer-to-peer level communication between the two network interface engines allows first network interface engine 1030a to send the content directly to second network interface engine 1030b via distributive interconnect 1080. If necessary, the content may also be routed through transport processing engine 1050, or through network transport processing engine 1050 and application processing engine 1070, in a manner described above.

Still yet other applications may exist in which the content required to be delivered is contained both in the attached content sources 1090 or 1100 and at other remote content sources. For example in a web caching application, not all content may be cached in the attached content sources, but rather some data may also be cached remotely. In such an application, the data and communication flow may be a combination of the various flows described above for content provided from the content sources 1090 and 1100 and for content provided from remote sources on the networks 1020 and/or 1024.

The content delivery system 1010 described above is configured in a peer-to-peer manner that allows the various engines and modules to communicate with each other directly as peers through the distributed interconnect. This is contrasted with a traditional server architecture in which there is a main CPU. Furthermore unlike the arbitrated bus of traditional servers, the distributed interconnect 1080 provides a switching means which is not arbitrated and allows multiple simultaneous communications between the various peers. The data and communication flow may by-pass unnecessary peers such as the return of data from the storage management processing engine 1060 directly to the network interface processing engine 1030 as described with reference to FIG. 11B.

Communications between the various processor engines may be made through the use of a standardized internal protocol. Thus, a standardized method is provided for routing through the switch fabric and communicating between any two of the processor engines which operate as peers in the peer to peer environment. The standardized internal protocol provides a mechanism upon which the external network protocols may “ride” upon or be incorporated within. In this manner additional internal protocol layers relating to internal communication and data exchange may be added to the external protocol layers. The additional internal layers may be provided in addition to the external layers or may replace some of the external protocol layers (for example as described above portions of the external headers may be replaced by identifiers or tags by the network interface engine).

The standardized internal protocol may consist of a system of message classes, or types, where the different classes can independently include fields or layers that are utilized to identify the destination processor engine or processor module for communication, control, or data messages provided to the switch fabric along with information pertinent to the corresponding message class. The standardized internal protocol may also include fields or layers that identify the priority that a data packet has within the content delivery system. These priority levels may be set by each processing engine based upon system-wide policies. Thus, some traffic within the content delivery system may be prioritized over other traffic and this priority level may be directly indicated within the internal protocol call scheme utilized to enable communications within the system. The prioritization helps enable the predictive traffic flow between engines and end-to-end through the system such that service level guarantees may be supported.

Other internally added fields or layers may include processor engine state, system timestamps, specific message class identifiers for message routing across the switch fabric and at the receiving processor engine(s), system keys for secure control message exchange, flow control information to regulate control and data traffic flow and prevent congestion, and specific address tag fields that allow hardware at the receiving processor engines to move specific types of data directly into system memory.

In one embodiment, the internal protocol may be structured as a set, or system of messages with common system defined headers that allows all processor engines and, potentially, processor engine switch fabric attached hardware, to interpret and process messages efficiently and intelligently. This type of design allows each processing engine, and specific functional entities within the processor engines, to have their own specific message classes optimized functionally for the exchanging their specific types control and data information. Some message classes that may be employed are: System Control messages for system management, Network Interface to Network Transport messages, Network Transport to Application Interface messages, File System to Storage engine messages, Storage engine to Network Transport messages, etc. Some of the fields of the standardized message header may include message priority, message class, message class identifier (subtype), message size, message options and qualifier fields, message context identifiers or tags, etc. In addition, the system statistics gathering, management and control of the various engines may be performed across the switch fabric connected system using the messaging capabilities.

By providing a standardized internal protocol, overall system performance may be improved. In particular, communication speed between the processor engines across the switch fabric may be increased. Further, communications between any two processor engines may be enabled. The standardized protocol may also be utilized to reduce the processing loads of a given engine by reducing the amount of data that may need to be processed by a given engine.

The internal protocol may also be optimized for a particular system application, providing further performance improvements. However, the standardized internal communication protocol may be general enough to support encapsulation of a wide range of networking and storage protocols. Further, while internal protocol may run on PCI, PCI-X, ATM, IB, Lightening I/O, the internal protocol is a protocol above these transport-level standards and is optimal for use in a switched (non-bus) environment such as a switch fabric. In addition, the internal protocol may be utilized to communicate devices (or peers) connected to the system in addition to those described herein. For example, a peer need not be a processing engine. In one example, a peer may be an ASIC protocol converter that is coupled to the distributed interconnect as a peer but operates as a slave device to other master devices within the system. The internal protocol may also be as a protocol communicated between systems such as used in the clusters described above.

Thus a system has been provided in which the networking/server clustering/storage networking has been collapsed into a single system utilizing a common low-overhead internal communication protocol/transport system.

Content Delivery Acceleration

As described above, a wide range of techniques have been provided for accelerating content delivery from the content delivery system 1010 to a network. By accelerating the speed at which content may be delivered, a more cost effective and higher performance system may be provided. These techniques may be utilized separately or in various combinations.

One content acceleration technique involves the use of a multi-engine system with dedicated engines for varying processor tasks. Each engine can perform operations independently and in parallel with the other engines without the other engines needing to freeze or halt operations. The engines do not have to compete for resources such as memory, I/O, processor time, etc. but are provided with their own resources. Each engine may also be tailored in hardware and/or software to perform specific content delivery task, thereby providing increasing content delivery speeds while requiring less system resources. Further, all data, regardless of the flow path, gets processed in a staged pipeline fashion such that each engine continues to process its layer of functionality after forwarding data to the next engine/layer.

Content acceleration is also obtained from the use of multiple processor modules within an engine. In this manner, parallelism may be achieved within a specific processing engine. Thus, multiple processors responding to different content requests may be operating in parallel within one engine.

Content acceleration is also provided by utilizing the multi-engine design in a peer to peer environment in which each engine may communicate as a peer. Thus, the communications and data paths may skip unnecessary engines. For example, data may be communicated directly from the storage processing engine to the transport processing engine without have to utilize resources of the application processing engine.

Acceleration of content delivery is also achieved by removing or stripping the contents of some protocol layers in one processing engine and replacing those layers with identifiers or tags for use with the next processor engine in the data or communications flow path. Thus, the processing burden placed on the subsequent engine may be reduced. In addition, the packet size transmitted across the distributed interconnect may be reduced. Moreover, protocol processing may be off-loaded from the storage and/or application processors, thus freeing those resources to focus on storage or application processing.

Content acceleration is also provided by using network processors in a network endpoint system. Network processors generally are specialized to perform packet analysis functions at intermediate network nodes, but in the content delivery system disclosed the network processors have been adapted for endpoint functions. Furthermore, the parallel processor configurations within a network processor allow these endpoint functions to be performed efficiently.

In addition, content acceleration has been provided through the use of a distributed interconnection such as a switch fabric. A switch fabric allows for parallel communications between the various engines and helps to efficiently implement some of the acceleration techniques described herein.

It will be recognized that other aspects of the content delivery system 1010 also provide for accelerated delivery of content to a network connection. Further, it will be recognized that the techniques disclosed herein may be equally applicable to other network endpoint systems and even non-endpoint systems.

Exemplary Hardware Embodiments

FIGS. 1C-1F illustrate just a few of the many multiple network content delivery engine configurations possible with one exemplary hardware embodiment of content delivery system 1010. In each illustrated configuration of this hardware embodiment, content delivery system 1010 includes processing modules that may be configured to operate as content delivery engines 1030, 1040, 1050, 1060, and 1070 communicatively coupled via distributive interconnection 1080. As shown in FIG. 1C, a single processor module may operate as the network interface processing engine 1030 and a single processor module may operate as the system management processing engine 1060. Four processor modules 1001 may be configured to operate as either the transport processing engine 1050 or the application processing engine 1070. Two processor modules 1003 may operate as either the storage processing engine 1040 or the transport processing engine 1050. The Gigabit (Gb) Ethernet front end interface 1022, system management interface 1062 and dual fibre channel arbitrated loop 1092 are also shown.

As mentioned above, the distributive interconnect 1080 may be a switch fabric based interconnect. As shown in FIG. 1C, the interconnect may be an IBM PRIZMA-E eight/sixteen port switch fabric 1081. In an eight port mode, this switch fabric is an 8×3.54 Gbps fabric and in a sixteen port mode, this switch fabric is a 16×1.77 Gbps fabric. The eight/sixteen port switch fabric may be utilized in an eight port mode for performance optimization. The switch fabric 1081 may be coupled to the individual processor modules through interface converter circuits 1082, such as IBM UDASL switch interface circuits. The interface converter circuits 1082 convert the data aligned serial link interface (DASL) to a UTOPIA (Universal Test and Operations PHY Interface for ATM) parallel interface. FPGAs (field programmable gate array) may be utilized in the processor modules as a fabric interface on the processor modules as shown in FIG. 1C. These fabric interfaces provide a 64/66 Mhz PCI interface to the interface converter circuits 1082. FIG. 4 illustrates a functional block diagram of such a fabric interface 34. As explained below, the interface 34 provides an interface between the processor module bus and the UDASL switch interface converter circuit 1082. As shown in FIG. 4, at the switch fabric side, a physical connection interface 41 provides connectivity at the physical level to the switch fabric. An example of interface 41 is a parallel bus interface complying with the UTOPIA standard. In the example of FIG. 4, interface 41 is a UTOPIA 3 interface providing a 32-bit 110 Mhz connection. However, the concepts disclosed herein are not protocol dependent and the switch fabric need not comply with any particular ATM or non ATM standard.

Still referring to FIG. 4, SAR (segmentation and reassembly) unit 42 has appropriate SAR logic 42a for performing segmentation and reassembly tasks for converting messages to fabric cells and vice-versa as well as message classification and message class-to-queue routing, using memory 42b and 42c for transmit and receive queues. This permits different classes of messages and permits the classes to have different priority. For example, control messages can be classified separately from data messages, and given a different priority. All fabric cells and the associated messages may be self routing, and no out of band signaling is required.

A special memory modification scheme permits one processor module to write directly into memory of another. This feature is facilitated by switch fabric interface 34 and in particular by its message classification capability. Commands and messages follow the same path through switch fabric interface 34, but can be differentiated from other control and data messages. In this manner, processes executing on processor modules can communicate directly using their own memory spaces.

Bus interface 43 permits switch fabric interface 34 to communicate with the processor of the processor module via the module device or I/O bus. An example of a suitable bus architecture is a PCI architecture, but other architectures could be used. Bus interface 43 is a master/target device, permitting interface 43 to write and be written to and providing appropriate bus control. The logic circuitry within interface 43 implements a state machine that provides the communications protocol, as well as logic for configuration and parity.

Referring again to FIG. 1C, network processor 1032 (for example a MOTOROLA C-Port C-5 network processor) of the network interface processing engine 1030 may be coupled directly to an interface converter circuit 1082 as shown. As mentioned above and further shown in FIG. 1C, the network processor 1032 also may be coupled to the network 1020 by using a VITESSE GbE SERDES (serializer-deserializer) device (for example the VSC7123) and an SFP (small form factor pluggable) optical transceiver for LC fibre connection.

The processor modules 1003 include a fibre channel (FC) controller as mentioned above and further shown in FIG. 1C. For example, the fibre channel controller may be the LSI SYMFC929 dual 2 GBaud fibre channel controller. The fibre channel controller enables communication with the fibre channel 1092 when the processor module 1003 is utilized as a storage processing engine 1040. Also illustrated in FIGS. 1C-1F is optional adjunct processing unit 1300 that employs a POWER PC processor with SDRAM. The adjunct processing unit is shown coupled to network processor 1032 of network interface processing engine 1030 by a PCI interface. Adjunct processing unit 1300 may be employed for monitoring system parameters such as temperature, fan operation, system health, etc.

As shown in FIGS. 1C-1F, each processor module of content delivery engines 1030, 1040, 1050, 1060, and 1070 is provided with its own synchronous dynamic random access memory (“SDRAM”) resources, enhancing the independent operating capabilities of each module. The memory resources may be operated as ECC (error correcting code) memory. Network interface processing engine 1030 is also provided with static random access memory (“SRAM”). Additional memory circuits may also be utilized as will be recognized by those skilled in the art. For example, additional memory resources (such as synchronous SRAM and non-volatile FLASH and EEPROM) may be provided in conjunction with the fibre channel controllers. In addition, boot FLASH memory may also be provided on the of the processor modules.

The processor modules 1001 and 1003 of FIG. 1C may be configured in alternative manners to implement the content delivery processing engines such as the network interface processing engine 1030, storage processing engine 1040, transport processing engine 1050, system management processing engine 1060, and application processing engine 1070. Exemplary configurations are shown in FIGS. 1D-1F, however, it will be recognized that other configurations may be utilized.

As shown in FIG. 1D, two Pentium III based processing modules may be utilized as network application processing modules 1070a and 1070b of network application processing engine 1070. The remaining two Pentium III-based processing modules are shown in FIG. 1D configured as network transport/protocol processing modules 1050a and 1050b of network transport/protocol processing engine 1050. The embodiment of FIG. 1D also includes two POWER PC-based processor modules, configured as storage management processing modules 1040a and 1040b of storage management processing engine 1040. A single MOTOROLA C-Port C-5 based network processor is shown employed as network interface processing engine 1030, and a single Pentium III-based processing module is shown employed as system management processing engine 1060.

In FIG. 1E, the same hardware embodiment of FIG. 1C is shown alternatively configured so that three Pentium III-based processing modules function as network application processing modules 1070a, 1070b and 1070c of network application processing engine 1070, and so that the sole remaining Pentium III-based processing module is configured as a network transport processing module 1050a of network transport processing engine 1050. As shown, the remaining processing modules are configured as in FIG. 1D.

In FIG. 1F, the same hardware embodiment of FIG. 1C is shown in yet another alternate configuration so that three Pentium III-based processing modules function as application processing modules 1070a, 1070b and 1070c of network application processing engine 1070. In addition, the network transport processing engine 1050 includes one Pentium III-based processing module that is configured as network transport processing module 1050a, and one POWER PC-based processing module that is configured as network transport processing module 1050b. The remaining POWER PC-based processor module is configured as storage management processing module 1040a of storage management processing engine 1040.

It will be understood with benefit of this disclosure that the hardware embodiment and multiple engine configurations thereof illustrated in FIGS. 1C-1F are exemplary only, and that other hardware embodiments and engine configurations thereof are also possible. It will further be understood that in addition to changing the assignments of individual processing modules to particular processing engines, distributive interconnect 1080 enables the vary processing flow paths between individual modules employed in a particular engine configuration in a manner as described in relation to FIG. 1B. Thus, for any given hardware embodiment and processing engine configuration, a number of different processing flow paths may be employed so as to optimize system performance to suit the needs of particular system applications.

Single Chassis Design

As mentioned above, the content delivery system 1010 may be implemented within a single chassis, such as for example, a 2U chassis. The system may be expanded further while still remaining a single chassis system. In particular, utilizing a multiple processor module or blade arrangement connected through a distributive interconnect (for example a switch fabric) provides a system that is easily scalable. The chassis and interconnect may be configured with expansion slots provided for adding additional processor modules. Additional processor modules may be provided to implement additional applications within the same chassis. Alternatively, additional processor modules may be provided to scale the bandwidth of the network connection. Thus, though describe with respect to a 1 Gbps Ethernet connection to the external network, a 10 Gbps, 40 Gbps or more connection may be established by the system through the use of more network interface modules. Further, additional processor modules may be added to address a system's particular bottlenecks without having to expand all engines of the system. The additional modules may be added during a systems initial configuration, as an upgrade during system maintenance or even hot plugged during system operation.

Alternative Systems Configurations

Further, the network endpoint system techniques disclosed herein may be implemented in a variety of alternative configurations that incorporate some, but not necessarily all, of the concepts disclosed herein. For example, FIGS. 2 and 2A disclose two exemplary alternative configurations. It will be recognized, however, that many other alternative configurations may be utilized while still gaining the benefits of the inventions disclosed herein.

FIG. 2 is a more generalized and functional representation of a content delivery system showing how such a system may be alternately configured to have one or more of the features of the content delivery system embodiments illustrated in FIGS. 1A-1F. FIG. 2 shows content delivery system 200 coupled to network 260 from which content requests are received and to which content is delivered. Content sources 265 are shown coupled to content delivery system 200 via a content delivery flow path 263 that may be, for example, a storage area network that links multiple content sources 265. A flow path 203 may be provided to network connection 272, for example, to couple content delivery system 200 with other network appliances, in this case one or more servers 201 as illustrated in FIG. 2.

In FIG. 2 content delivery system 200 is configured with multiple processing and memory modules that are distributively interconnected by inter-process communications path 230 and inter-process data movement path 235. Inter-process communications path 230 is provided for receiving and distributing inter-processor command communications between the modules and network 260, and interprocess data movement path 235 is provided for receiving and distributing inter-processor data among the separate modules. As illustrated in FIGS. 1A-1F, the functions of inter-process communications path 230 and inter-process data movement path 235 may be together handled by a single distributive interconnect 1080 (such as a switch fabric, for example), however, it is also possible to separate the communications and data paths as illustrated in FIG. 2, for example using other interconnect technology.

FIG. 2 illustrates a single networking subsystem processor module 205 that is provided to perform the combined functions of network interface processing engine 1030 and transport processing engine 1040 of FIG. 1A. Communication and content delivery between network 260 and networking subsystem processor module 205 are made through network connection 270. For certain applications, the functions of network interface processing engine 1030 and transport processing engine 1050 of FIG. 1A may be so combined into a single module 205 of FIG. 2 in order to reduce the level of communication and data traffic handled by communications path 230 and data movement path 235 (or single switch fabric), without adversely impacting the resources of application processing engine or subsystem module. If such a modification were made to the system of FIG. 1A, content requests may be passed directly from the combined interface/transport engine to network application processing engine 1070 via distributive interconnect 1080. Thus, as previously described the functions of two or more separate content delivery system engines may be combined as desired (e.g., in a single module or in multiple modules of a single processing blade), for example, to achieve advantages in efficiency or cost.

In the embodiment of FIG. 2, the function of network application processing engine 1070 of FIG. 1A is performed by application processing subsystem module 225 of FIG. 2 in conjunction with application RAM subsystem module 220 of FIG. 2. System monitor module 240 communicates with server/s 201 through flow path 203 and Gb Ethernet network interface connection 272 as also shown in FIG. 2. The system monitor module 240 may provide the function of the system management engine 1060 of FIG. 1A and/or other system policy/filter functions such as may also be implemented in the network interface processing engine 1030 as described above with reference to FIG. 1A.

Similarly, the function of network storage management engine 1040 is performed by storage subsystem module 210 in conjunction with file system cache subsystem module 215. Communication and content delivery between content sources 265 and storage subsystem module 210 are shown made directly through content delivery flowpath 263 through fibre channel interface connection 212. Shared resources subsystem module 255 is shown provided for access by each of the other subsystem modules and may include, for example, additional processing resources, additional memory resources such as RAM, etc.

Additional processing engine capability (e.g., additional system management processing capability, additional application processing capability, additional storage processing capability, encryption/decryption processing capability, compression/decompression processing capability, encoding/decoding capability, other processing capability, etc.) may be provided as desired and is represented by other subsystem module 275. Thus, as previously described the functions of a single network processing engine may be sub-divided between separate modules that are distributively interconnected. The sub-division of network processing engine tasks may also be made for reasons of efficiency or cost, and/or may be taken advantage of to allow resources (e.g., memory or processing) to be shared among separate modules. Further, additional shared resources may be made available to one or more separate modules as desired.

Also illustrated in FIG. 2 are optional monitoring agents 245 and resources 250. In the embodiment of FIG. 2, each monitoring agent 245 may be provided to monitor the resources 250 of its respective processing subsystem module, and may track utilization of these resources both within the overall system 200 and within its respective processing subsystem module. Examples of resources that may be so monitored and tracked include, but are not limited to, processing engine bandwidth, Fibre Channel bandwidth, number of available drives, IOPS (input/output operations per second) per drive and RAID (redundant array of inexpensive discs) levels of storage devices, memory available for caching blocks of data, table lookup engine bandwidth, availability of RAM for connection control structures and outbound network bandwidth availability, shared resources (such as RAM) used by streaming application on a per-stream basis as well as for use with connection control structures and buffers, bandwidth available for message passing between subsystems, bandwidth available for passing data between the various subsystems, etc.

Information gathered by monitoring agents 245 may be employed for a wide variety of purposes including for billing of individual content suppliers and/or users for pro-rata use of one or more resources, resource use analysis and optimization, resource health alarms, etc. In addition, monitoring agents may be employed to enable the deterministic delivery of content by system 200 as described in concurrently filed, co-pending U.S. patent application Ser. No. ______, entitled “System and Method for the Deterministic Delivery of Data and Services,” which is incorporated herein by reference.

In operation, content delivery system 200 of FIG. 2 may be configured to wait for a request for content or services prior to initiating content delivery or performing a service. A request for content, such as a request for access to data, may include, for example, a request to start a video stream, a request for stored data, etc. A request for services may include, for example, a request for to run an application, to store a file, etc. A request for content or services may be received from a variety of sources. For example, if content delivery system 200 is employed as a stream server, a request for content may be received from a client system attached to a computer network or communication network such as the Internet. In a larger system environment, e.g., a data center, a request for content or services may be received from a separate subcomponent or a system management processing engine, that is responsible for performance of the overall system or from a sub-component that is unable to process the current request. Similarly, a request for content or services may be received by a variety of components of the receiving system. For example, if the receiving system is a stream server, networking subsystem processor module 205 might receive a content request. Alternatively, if the receiving system is a component of a larger system, e.g., a data center, system management processing engine may be employed to receive the request.

Upon receipt of a request for content or services, the request may be filtered by system monitor 240. Such filtering may serve as a screening agent to filter out requests that the receiving system is not capable of processing (e.g., requests for file writes from read-only system embodiments, unsupported protocols, content/services unavailable on system 200, etc.). Such requests may be rejected outright and the requester notified, may be re-directed to a server 201 or other content delivery system 200 capable of handling the request, or may be disposed of any other desired manner.

Referring now in more detail to one embodiment of FIG. 2 as may be employed in a stream server configuration, networking processing subsystem module 205 may include the hardware and/or software used to run TCP/IP (Transmission Control Protocol/Internet Protocol), UDP/IP (User Datagram Protocol/Internet Protocol), RTP (Real-Time Transport Protocol), Internet Protocol (IP), Wireless Application Protocol (WAP) as well as other networking protocols. Network interface connections 270 and 272 may be considered part of networking subsystem processing module 205 or as separate components. Storage subsystem module 210 may include hardware and/or software for running the Fibre Channel (FC) protocol, the SCSI (Small Computer Systems Interface) protocol, iSCSI protocol as well as other storage networking protocols. FC interface 212 to content delivery flowpath 263 may be considered part of storage subsystem module 210 or as a separate component. File system cache subsystem module 215 may include, in addition to cache hardware, one or more cache management algorithms as well as other software routines.

Application RAM subsystem module 220 may function as a memory allocation subsystem and application processing subsystem module 225 may function as a stream-serving application processor bandwidth subsystem. Among other services, application RAM subsystem module 220 and application processing subsystem module 225 may be used to facilitate such services as the pulling of content from storage and/or cache, the formatting of content into RTSP (Real-Time Streaming Protocol) or another streaming protocol as well the passing of the formatted content to networking subsystem 205.

As previously described, system monitor module 240 may be included in content delivery system 200 to manage one or more of the subsystem processing modules, and may also be used to facilitate communication between the modules.

In part to allow communications between the various subsystem modules of content delivery system 200, inter-process communication path 230 may be included in content delivery system 200, and may be provided with its own monitoring agent 245. Inter-process communications path 230 may be a reliable protocol path employing a reliable IPC (Inter-process Communications) protocol. To allow data or information to be passed between the various subsystem modules of content delivery system 200, inter-process data movement path 235 may also be included in content delivery system 200, and may be provided with its own monitoring agent 245. As previously described, the functions of inter-process communications path 230 and inter-process data movement path 235 may be together handled by a single distributive interconnect 1080, that may be a switch fabric configured to support the bandwidth of content being served.

In one embodiment, access to content source 265 may be provided via a content delivery flow path 263 that is a fibre channel storage area network (SAN), a switched technology. In addition, network connectivity may be provided at network connection 270 (e.g., to a front end network) and/or at network connection 272 (e.g., to a back end network) via switched gigabit Ethernet in conjunction with the switch fabric internal communication system of content delivery system 200. As such, that the architecture illustrated in FIG. 2 may be generally characterized as equivalent to a networking system.

One or more shared resources subsystem modules 255 may also be included in a stream server embodiment of content delivery system 200, for sharing by one or more of the other subsystem modules. Shared resources subsystem module 255 may be monitored by the monitoring agents 245 of each subsystem sharing the resources. The monitoring agents 245 of each subsystem module may also be capable of tracking usage of shared resources 255. As previously described, shared resources may include RAM (Random Access Memory) as well as other types of shared resources.

Each monitoring agent 245 may be present to monitor one or more of the resources 250 of its subsystem processing module as well as the utilization of those resources both within the overall system and within the respective subsystem processing module. For example, monitoring agent 245 of storage subsystem module 210 may be configured to monitor and track usage of such resources as processing engine bandwidth, Fibre Channel bandwidth to content delivery flow path 263, number of storage drives attached, number of input/output operations per second (IOPS) per drive and RAID levels of storage devices that may be employed as content sources 265. Monitoring agent 245 of file system cache subsystem module 215 may be employed monitor and track usage of such resources as processing engine bandwidth and memory employed for caching blocks of data. Monitoring agent 245 of networking subsystem processing module 205 may be employed to monitor and track usage of such resources as processing engine bandwidth, table lookup engine bandwidth, RAM employed for connection control structures and outbound network bandwidth availability. Monitoring agent 245 of application processing subsystem module 225 may be employed to monitor and track usage of processing engine bandwidth. Monitoring agent 245 of application RAM subsystem module 220 may be employed to monitor and track usage of shared resource 255, such as RAM, which may be employed by a streaming application on a per-stream basis as well as for use with connection control structures and buffers. Monitoring agent 245 of inter-process communication path 230 may be employed to monitor and track usage of such resources as the bandwidth used for message passing between subsystems while monitoring agent 245 of inter-process data movement path 235 may be employed to monitor and track usage of bandwidth employed for passing data between the various subsystem modules.

The discussion concerning FIG. 2 above has generally been oriented towards a system designed to deliver streaming content to a network such as the Internet using, for example, Real Networks, Quick Time or Microsoft Windows Media streaming formats. However, the disclosed systems and methods may be deployed in any other type of system operable to deliver content, for example, in web serving or file serving system environments. In such environments, the principles may generally remain the same. However for application processing embodiments, some differences may exist in the protocols used to communicate and the method by which data delivery is metered (via streaming protocol, versus TCP/IP windowing).

FIG. 2A illustrates an even more generalized network endpoint computing system that may incorporate at least some of the concepts disclosed herein. As shown in FIG. 2A, a network endpoint system 10 may be coupled to an external network 11. The external network 11 may include a network switch or router coupled to the front end of the endpoint system 10. The endpoint system 10 may be alternatively coupled to some other intermediate network node of the external network. The system 10 may further include a network engine 9 coupled to an interconnect medium 14. The network engine 9 may include one or more network processors. The interconnect medium 14 may be coupled to a plurality of processor units 13 through interfaces 13a. Each processor unit 13 may optionally be couple to data storage (in the exemplary embodiment shown each unit is couple to data storage). More or less processor units 13 may be utilized than shown in FIG. 2A.

The network engine 9 may be a processor engine that performs all protocol stack processing in a single processor module or alternatively may be two processor modules (such as the network interface engine 1030 and transport engine 1050 described above) in which split protocol stack processing techniques are utilized. Thus, the functionality and benefits of the content delivery system 1010 described above may be obtained with the system 10. The interconnect medium 14 may be a distributive interconnection (for example a switch fabric) as described with reference to FIG. 1A. All of the various computing, processing, communication, and control techniques described above with reference to FIGS. 1A-1F and 2 may be implemented within the system 10. It will therefore be recognized that these techniques may be utilized with a wide variety of hardware and computing systems and the techniques are not limited to the particular embodiments disclosed herein.

The system 10 may consist of a variety of hardware configurations. In one configuration the network engine 9 may be a stand-alone device and each processing unit 13 may be a separate server. In another configuration the network engine 9 may be configured within the same chassis as the processing units 13 and each processing unit 13 may be a separate server card or other computing system. Thus, a network engine (for example an engine containing a network processor) may provide transport acceleration and be combined with multi-server functionality within the system 10. The system 10 may also include shared management and interface components. Alternatively, each processing unit 13 may be a processing engine such as the transport processing engine, application engine, storage engine, or system management engine of FIG. 1A. In yet another alternative, each processing unit may be a processor module (or processing blade) of the processor engines shown in the system of FIG. 1A.

FIG. 2B illustrates yet another use of a network engine 9. As shown in FIG. 2B, a network engine 9 may be added to a network interface card 35. The network interface card 35 may further include the interconnect medium 14 which may be similar to the distributed interconnect 1080 described above. The network interface card may be part of a larger computing system such as a server. The network interface card may couple to the larger system through the interconnect medium 14. In addition to the functions described above, the network engine 9 may perform all traditional functions of a network interface card.

It will be recognized that all the systems described above (FIGS. 1A, 2, 2A, and 2B) utilize a network engine between the external network and the other processor units that are appropriate for the function of the particular network node. The network engine may therefore offload tasks from the other processors. The network engine also may perform “look ahead processing” by performing processing on a request before the request reaches whatever processor is to perform whatever processing is appropriate for the network node. In this manner, the system operations may be accelerated and resources utilized more efficiently.

Load Balancing

As mentioned above, the techniques disclosed herein allow various levels of load balancing to satisfy a work request. At a system hardware level, the functionality of the hardware may be assigned in a manner that optimizes the system performance for a given load. At the workload level, loads may be balanced between multiple processing modules of a system to further optimize the system performance.

Examples of load balancing with respect to the functional assignment of system hardware are shown with respect FIGS. 1C-1F. In FIGS. 1C-1F, multiple processor modules are provided that may be alternatively assigned to different content delivery system engines. The amount of processor modules assigned to one system engine may be varied depending on the tasks. For example, when the system is performing application processing intensive tasks additional processing modules may be assigned the application engine functionality. If the tasks are storage intensive, additional processor modules may be utilized in the storage management processor engine to meet the demand for more storage processor resources. Similarly, additional resources may be assigned to the transport processing engine as needed. Thus, by providing interchangeable processor modules the hardware is configurable so that the functionality of the various processor modules may be assigned based upon the resources required for a task. In this manner a dynamically re-configurable system is provided that may be adapted to the workload present.

In one embodiment, the amount of resources dedicated towards a specific processing engine of a system (such as system 1010 of FIG. 1C) may be configured once. In such an embodiment, the system may be generally utilized to only perform a single type of task, and thus, the system may be one time configured to allocate the processing resources in the manner most efficient for that task. For example, a system may be configured to perform only streaming content delivery tasks, only web page caching tasks, only live broadcast content delivery tasks, etc.

In another embodiment, the system may be anticipated to perform two or more different types of tasks. In such an embodiment, the system may be reconfigured when the specific type of task to be performed changes. Thus, the optimal allocation of resources for a specific type of task may be chosen.

In yet another embodiment of load balancing hardware functional assignments, load balancing may be performed in response to system wellness/failure analysis. In such an embodiment, if one processor module of the system fails to operate properly the inoperative processor module may be taken off-line. The functionality of the remaining processor modules may then be reassigned based upon a new determination of the optimal allocation of resources. Load balancing hardware in response to the detection of a system resource failure may be seen with respect to an example utilizing the configuration of FIG. 1D. As shown in FIG. 1D, two processing modules may be utilized as the application processing modules 1070a and 1070b of the application processing engine 1070. In addition, two processing modules may be utilized as the transport processing modules 1050a and 1050b of the transport processing engine 1050. If the processing module 1070b becomes inoperative, the processing module 1070b may be taken off-line and the hardware resources re-optimized. If the tasks being performed require more application resources than transport resources, then one of the modules 1050a or 1050b may be reassigned the application functionality and utilized as part of the application processing engine. It will be recognized that this illustration of resource reassignment (load balancing) in response to a wellness/failure event is just exemplary and many other reassignments of resources may be accomplished based upon the amount of resources provided and the amount of resources required for a particular task(s).

After a hardware configuration is assigned, additional load balancing may be accomplished by balancing the routing of data and communication flow through a system such as the content delivery system 1010 of FIG. 1A, the content delivery system 200 of FIG. 2 or the network endpoint system 10 of FIG. 2A. These load balancing techniques may replace the techniques associated with a load balancing switch placed at the front end of a conventional multi-server endpoint system. As shown herein, a processing engine or module including a network processor may perform at least some of the data and communication flow load balancing tasks.

With reference to the network endpoint system 10 of FIG. 2A, the network processor 12 may receive network traffic in the form of “sessions” (sometimes referred to as logical connections) and distributes the sessions to the processing units 13. Where processing units 13 do not have hard coded addresses, network processor 12 may be used to implement a load balancing algorithm. Network processor 12 therefore performs load balancing, distributing network sessions among processing units 13, which perform various tasks. The load balancing algorithm is used to select which processing unit 13 is to receive the session. A session-based approach to load balancing may be optimal when each session has only one request. For content provider endpoints that expect multiple requests per session, other algorithms, such as request-based load balancing algorithms, can be used.

A more detailed illustration of load balancing may be seen with reference to the data and communication flow paths of FIG. 1B. As shown in FIG. 1B, a network interface module 1030A (which includes a network processor) may receive a request. Based upon a load balancing algorithm, the network interface module 1030A may determine if the request will be further routed to the transport module 1050A or the transport module 1050B. Thus, the module that performs the next level of processing for the request is determined based upon the load balancing algorithm.

The load balancing determination initially made with the network interface module 1030A may also include a determination of all the subsequent data and communication flows. Thus, the network interface module 1030A may also determine which application module 1070A or 1070B will process the request after the transport module has processed the request. In one embodiment, the data and communication flows may be constant once a given transport module 1050A or 1050B is selected. In another embodiment, the network interface module 1030A may independently select which application module receives a request from any transport module. Although FIG. 1B shows the communication flow from transport module 1050A to application module 1070A, other communication flows may be selected. Thus, the communication flow may be selected to proceed from transport module 1050A to application module 1070B if the balancing of workloads dictates such a communication flow.

Yet another embodiment of load balancing may be accomplished by distributing the load balancing determinations to each stage of the endpoint system. With respect to FIG. 1B, in response to a request the network interface module 1030A may select a transport module 1050A or 1050B based upon a load balancing algorithm. The transport module may then select either application module 1070A or 1070B to continue processing the request. Similarly, the selected application module may perform a load balancing decision to select a specific storage management module and the storage management module may provide the requested data to a transport module 1050A or 1050B based upon further load balancing. Thus at each stage of the pipelined processing, load balancing may occur.

By implementing load balancing techniques, the resources of the network endpoint system may be more fully utilized. The data and communication load balancing techniques described herein provide a network endpoint computing system in which the load balancing is performed at the endpoint. Moreover, a network processor may be utilized in the network endpoint system to accomplish at least some of the load balance. The use of a distributed interconnect, in one example a switch fabric, further enhances the performance and flexibility of the load balancing techniques.

Any of a wide variety of load balancing algorithms may be utilized. Because of the direct link across an interconnection medium such as a switch fabric, either simple or sophisticated load balancing algorithms may be implemented. One type of a simple load balancing algorithm is a round robin algorithm. In a round robin approach the requests are directed to each processing unit in a sequential order. A weighted round robin approach may also be utilized in which a weighting scheme may be added to the round robin selection to prefer or favor particular data paths or processors.

The load balancing algorithms can also be dependent upon feedback information acquired from processors such as, for example, the processor modules of FIG. 1C or the processing units 13 of FIG. 2A. Using FIG. 2A for illustration, the processing units 13 may provide feedback to the network processor 12 to indicate that the processing unit is available for another workload or to indicate when the processing unit will become available. Load balancing algorithms may also be based on feedback as to the queue depth at the next module in a pipelined processing system. Another sophisticated load balancing technique may be based upon estimations of the resources required to perform a task and estimations of available resources based upon prior tasks or actual available resources based upon some level of feedback. Other user or application specific load balancing policies may be programmably selected as the system described herein provides for the flexible implementation of various load balance techniques.

All of the algorithms discussed above may incorporate wellness checking. Information about a processor unit failure may be provided to the network processor (or another monitoring processor) that is programmed to implement fault detection and tolerance algorithms. For example, application programming interfaces (APIs) can be used to convey intelligent information about application load and processing behavior at any given processor by sending state and statistical information to the monitoring processor. Thus as part of the load balancing, wellness checks of the processor modules may be occur in real time and a processor module may be skipped in the assignment of a load if the wellness check indicates improper functioning of the processor module. The malfunctioning processor module may be skipped for all subsequent loads or may be re-tested periodically.

In addition to detecting a malfunctioning processor module, statistical analysis of the overall system performance may be integrated into the load balancing policies. Thus, the results being obtained from a load balancing algorithm may be tracked and the load balancing algorithm may be adjusted as needed. For example, a simple round robin load balancing algorithm may be initially implemented for balancing new connections to the system. However, during operation statistical monitoring may indicate that a given processor module has more or less load. In this case the round robin algorithm may be altered to weight loads to or away from the given processor module as needed to better balance the loads amongst all processor modules. The load balancing techniques may thus incorporate feedback related statistical monitoring of the system performance.

In addition, the programmable nature of network processors allows the load balancing algorithm to be programmably selected based upon the type of work tasks to be performed. When the type of task changes, the load balancing algorithm may then be changed. The load balancing algorithm may also direct work loads to a specific processor module or set of modules loads based upon the type of request (HTTP, streaming, etc.) that generated the work load. Different load balancing policies may also be implemented based upon the number of potential processing modules available for processing, or other user set criteria or policies. The use of a distributed interconnect such as a switch fabric and the use of programmable network processors enable various load balancing policies and algorithms to be implemented with a common hardware configuration. Thus, a flexible load balancing mechanism is provided that can be altered depending upon a number of different variables or criteria (even user configurable policies).

An example of a round robin load balancing algorithm will be described for the network endpoint system of FIG. 2A. In the system of FIG. 2A, the network processor 12 emulates a single destination network node and may use the port numbers in the network packet headers to distribute data types to processing units 13 that handle those data types. Port numbers are values in the network packet headers that identify the type of network data, and are used by the predominant network protocols, such as IP and IPX. The port numbers also identify network applications, such as HTTP, FTP, RTSP and others. More than one processing unit 13 may be a member of a “set” of processing units that have identical processing capabilities for a certain data type (such one or more modules in the set of modules for a particular processing engine as described with respect to FIGS. 1A-1F). When the processor 12 receives a request for a particular network application, the processor may assign the task in a round robin manner to the next available processing unit 13 on the list of processing units 13 that have capabilities for that certain application. In this manner, processing may be partitioned among processing units 13 based on the type of data—HTTP, FTP, RTSP, etc.

After a connection is established, the processor 12 may route subsequent traffic for that connection to the same processor units 13 by use of the unique set of source and destination network address with the protocol port numbers for that connection. Alternatively, subsequent traffic may be routed to the same processor units by use of a network address translation scheme. In such a scheme the Processor 12 is associated with a network address at its interface to the external network and its other interface is associated with addresses of processing units 13. Processor 12 translates incoming network data traffic to the address of the destination processing unit.

The load balancing algorithms described above may be utilized for each new request or connection to the network endpoint system. Subsequent loads for an established connection may than be sent to the same processing module(s). Thus, workloads for an established connection may follow the path selected when the connection was first established. For example, load balancing may be performed when a TCP connect request for content delivery is provided to the system and all of the data and communication paths for that session may be selected at the connect time. Alternatively, the data and communication flow may be load balanced even within an established connection so that the path selected for a given connection may not always remain constant.

The load balancing algorithms described herein may also be implemented to allow total redundancy. Thus, every workload may be assigned to duplicate processing engines that run simultaneously. Thus, a pair of processor modules (or a pair of groups of processor modules) could each process a copy of a request with the output of one of the pair of processor modules used only in the event of failure of the other of the pair. By having total redundancy, the system may complete the requested tasks even if a failure or fault occurs in one of the components or sub-components of one of the redundant data and communication paths. In this manner the network endpoint system may be configured in an active fault tolerant manner.

It will be understood with benefit of this disclosure that although specific exemplary embodiments of hardware and software have been described herein, other combinations of hardware and/or software may be employed to achieve one or more features of the disclosed systems and methods. Furthermore, it will be understood that operating environment and application code may be modified as necessary to implement one or more aspects of the disclosed technology, and that the disclosed systems and methods may be implemented using other hardware models as well as in environments where the application and operating system code may be controlled.

What is claimed is:

1. A network processing endpoint system for responding to network requests incoming via a network, comprising:
a network processor programmed to receive the network requests and to provide load balancing of network processing for the requests;
a set of processing units programmed to receive the requests from the network processor, to respond to the requests, and to deliver response data to the network processor; and
an interconnection medium for directly connecting the network processor to the processing units, such that the latency of the connections is determinable.

2. The system of claim 1, wherein the interconnection medium is a bus.

3. The system of claim 1, wherein the interconnection medium is a switch fabric.

4. The system of claim 1, wherein the interconnection medium is shared memory.

5. The system of claim 1, wherein the system is contained within a single chassis.

6. The system of claim 1, wherein the network is the Internet and the network processor is further programmed to process at least part of protocol processing.

7. The system of claim 1, wherein the network processor is further programmed to detect failures of the processing units.

8. The system of claim 7, wherein the network processor is further programmed to respond to the failures.

9. The system of claim 1, wherein the processing units are configured as redundant pairs of processing units.

10. The system of claim 1, wherein the load balancing is on the basis of sessions represented by the requests.

11. A method for processing network data at a network endpoint that responds to network requests via a network, comprising the steps of:
using a network processor to receive the network sessions and to provide load balancing of network processing for the requests;
using a set of processing units to receive the requests from the network processor, to respond to requests, and to deliver response data to the network processor; and
directly connecting the network processor to the processing units via an interconnection medium having determinable latency.

12. The method of claim 11, wherein the interconnection medium is a bus.

13. The method of claim 11, wherein the interconnection medium is a switch fabric.

14. The method of claim 11, wherein the interconnection medium is shared memory.

15. The method of claim 11, further comprising the step of housing the network processor, the processing units, and the interconnection medium in a single chassis.

16. The method of claim 11, wherein the network is the Internet and the network processor processes at least part of protocol processing.

17. The method of claim 11, further comprising the step of using the network processor to detect failures of the processing units.

18. The method of claim 17, further comprising the step of using the network processor to respond to the failures.

19. The method of claim 11, wherein the load balancing is on the basis of sessions represented by the requests.

20. A network connectable computing system, the system being configured to be connected on at least one end to a network, the system comprising:
a network interface engine comprising at least one network processor, the network interface engine coupling data from the network to the computing system;
a plurality of system processors for performing system functionality;
a distributed interconnection between the plurality of system processors and the network interface engine,
wherein the system enables load balancing to improve system performance.

21. The network connectable computing system of claim 20, further comprising a plurality of system processor engines, each system processor engines comprising one or more of the system processors, at least two of the system processor engines performing different tasks, the system being configured such that processor resources of a first system engine may be reassigned to a second system engine which performs tasks different from the first system engine in order to perform the load balancing.

22. The network connectable computing system of claim 21, wherein the plurality of system processor engines includes at least one of a transport processor engine, an application processor engine or a storage processor engine.

23. The network connectable computing system of claim 22, wherein the first system engine is an application processor engine and the second system engine is a transport processor engine.

24. The network connectable computing system of claim 22, wherein the first system engine is a storage processor engine and the second system engine is a transport processor engine.

25. The network connectable computing system of claim 20, further comprising a first system processor engine, the first system processor engine comprising a two or more of the system processors, wherein the load balancing is performed by assigning workloads between the two or more system processors of the first system processor engine.

26. The network connectable computing system of claim 25, the assignment of workloads performed at least in part by the network interface engine.

27. The network connectable computing system of claim 26, further comprising a second system processor engine, the second system processor engine comprising a two or more of the system processors, wherein the load balancing is also performed by assigning workloads between the two or more system processors of the second system processor engine.

28. The network connectable computing system of claim 27, the assignment of workloads in the first and second system processor engines performed at least in part by the network interface engine.

29. The network connectable computing system of claim 28, wherein the plurality of system processor engines includes at least one of a transport processor engine, an application processor engine or a storage processor engine.

30. The network connectable computing system of claim 28, wherein at least the first system processor engine, the second system processor engine and the network interface engine communicate in a peer to peer environment across a distributed interconnect.

31. The network connectable computing system of claim 30, wherein the interconnection is a switch fabric.

32. A method of configuring a network endpoint computing system for load balancing, comprising:
providing a network interface engine comprising at least one network processor, the network interface engine coupling data from the network to the computing system;
providing a plurality of system processing engines for performing different endpoint related tasks within the system;
a distributed interconnection between the plurality of system processing engines and the network interface engine,
load balancing the system to improve system performance.

33. The method of claim 32, wherein, each system processor engines comprising one or more system processors, at least two of the system processor engines performing different tasks, the system being configured such that processor resources of a first system engine may be reassigned to a second system engine which performs tasks different from the first system engine in order to perform the load balancing.

34. The method of claim 33, wherein the plurality of system processor engines includes at least one of a transport processor engine, an application processor engine or a storage processor engine.

35. The method of claim 34, wherein the first system engine is an application processor engine and the second system engine is a transport processor engine.

36. The method of claim 34, wherein the first system engine is a storage processor engine and the second system engine is a transport processor engine.

37. The method of claim 32, the plurality of system processing engines comprising a first system processor engine, the first system processor engine comprising a two or more of system processors, wherein the load balancing is performed by assigning workloads between the two or more system processors of the first system processor engine.

38. The method of claim 37, the assignment of workloads performed at least in part by the network interface engine.

39. The method of claim 37, the plurality of system processing engines further comprising a second system processor engine, the second system processor engine comprising a two or more of system processors, wherein the load balancing is also performed by assigning workloads between the two or more system processors of the second system processor engine.

40. The method of claim 39, the assignment of workloads in the first and second system processor engines performed at least in part by the network interface engine.

41. The method of claim 39, wherein the plurality of system processor engines includes at least one of a transport processor engine, an application processor engine or a storage processor engine.

42. The method of claim 39, wherein at least the first system processor engine, the second system processor engine and the network interface engine communicate in a peer to peer environment across a distributed interconnect.

43. The method of claim 42, wherein the distributed interconnection has a determinable latency

44. The method of claim 43, the distributed interconnection being a switch fabric.

45. A method of operating a network endpoint computing system for load balancing, comprising:
coupling data from a network to the computing system through a network interface engine;
providing a plurality of system processing engines for performing different endpoint related tasks within the system;
configuring the network interface engine and the plurality of system processing engines as peers in a peer to peer environment;
communicating between the peers through a distributed interconnection having determinable latencies; load balancing the system.

46. The method of claim 45, wherein the load balancing comprises assigning hardware processing resources amongst different system processing engines.

47. The method of claim 45, wherein two or more of the system processing engines have different dedicated tasks.

48. The method of claim 45, wherein the load balancing comprises allocated workloads amongst separate processor resources amongst the same system processing engine.

49. The method of claim 48, wherein the load balancing is based upon a round robin load balancing.

50. The method of claim 48, wherein the load balancing is based upon a weighed round robin load balancing.

51. The method of claim 48, wherein the load balancing is based upon the type of requests contained with the data incoming to the computing system.

52. The method of claim 48, wherein the load balancing is based upon feedback regarding system performance provided from one or more system resources.

53. The method of claim 48, wherein a load balancing decision is made on a data session by data session basis.

54. The method of claim 48, wherein the load balancing is implemented at least in part through the network interface engine.

55. The method of claim 48, wherein the system processing engines are arranged in a staged pipelined configuration, load balancing decisions being performed by a plurality of the stages of the pipelined configuration.

56. The method of claim 45, wherein the load balancing considers at least in part system wellness data.

57. The method of claim 45, wherein the load balancing considers at least in part system performance feedback.

58. The method of claim 45, wherein the network interface engine comprises a network processor, the method further comprising analyzing incoming data packet headers with the network processor.

59. The method of claim 58, wherein two or more of the system processing engines have different dedicated tasks.

60. The method of claim 58, wherein the load balancing comprises allocated workloads amongst separate processor resources amongst the same system processing engine.

61. The method of claim 60, wherein the load balancing is based upon a round robin load balancing.

62. The method of claim 60, wherein the load balancing is based upon a weighed round robin load balancing.

63. The method of claim 60, wherein the load balancing is based upon the type of requests contained with the data incoming to the computing system.

64. The method of claim 60, wherein the load balancing is based upon feedback regarding system performance provided from one or more system resources.

65. The method of claim 60, wherein a load balancing decision is made on a data session by data session basis.

66. The method of claim 60, wherein the load balancing is implemented at least in part through the network interface engine.

67. The method of claim 60, wherein the system processing engines are arranged in a staged pipelined configuration, load balancing decisions being performed by a plurality of the stages of the pipelined configuration.

68. The method of claim 58, wherein the load balancing considers at least in part system wellness data.

69. The method of claim 58, wherein the load balancing considers at least in part system performance feedback.

70. A network endpoint system for performing endpoint functionality, the endpoint system comprising, the system comprising:
a network interface engine comprising at least one network processor, the network interface engine coupling data from the network to the computing system;
a plurality of system processors for performing endpoint system functionality;
a distributed interconnection between the plurality of system processors and the network interface engine,
wherein the system enables workload load balancing.

71. The system of claim 70, further comprising a plurality of system processor engines, each system processor engines comprising one or more of the system processors, at least two of the system processor engines performing different tasks, the system being configured such that processor resources of a first system engine may be reassigned to a second system engine which performs tasks different from the first system engine in order to perform the hardware assignment load balancing.

72. The system of claim 71, wherein the plurality of system processor engines includes at least one of a transport processor engine, an application processor engine or a storage processor engine.

73. The system of claim 72, wherein the first system engine is an application processor engine and the second system engine is a transport processor engine.

74. The system of claim 72, wherein the first system engine is a storage processor engine and the second system engine is a transport processor engine.

75. The system of claim 70, further comprising a first system processor engine, the first system processor engine comprising a two or more of the system processors, wherein the load balancing is performed by assigning workloads between the two or more system processors of the first system processor engine.

76. The system of claim 75, the assignment of workloads performed at least in part by the network interface engine.

77. The system of claim 76, further comprising a second system processor engine, the second system processor engine comprising a two or more of the system processors, wherein the load balancing is also performed by assigning workloads between the two or more system processors of the second system processor engine.

78. The system of claim 75, wherein the plurality of system processors comprises at least one storage processor and at least one application processor.

79. The system of claim 78, wherein the network processor, the storage processor and the application processor operate in a peer to peer environment across the distributed interconnection.

80. The system of claim 79, wherein the distributed interconnection is a switch fabric.

81. The system of claim 70, wherein the network endpoint system is a content delivery system.

82. The system of claim 81 wherein:
the plurality of system processors comprises at least one storage processor and at least one application processor, the storage processor being configured to interface with a storage system; and
the network processor, the storage processor and the application processor operate in a peer to peer environment across the distributed interconnection.

83. The system of claim 82 wherein the distributed interconnection is a switch fabric.

84. The system of claim 83, wherein the system is configured in a single chassis.

85. A network connectable computing system, the system being configured to be connected on at least one end to a network, the system comprising:
a network interface engine comprising at least one network processor, the network interface engine coupling data from the network to the computing system;
a plurality of system processor engines providing system functionality processing;
a distributed interconnection between the plurality of system processor engines and the network interface engine, the distributed interconnection having a known latency,
wherein the system enables load balancing to improve system performance.

86. The system of claim 85, wherein the network processor analyzes headers of the data packets provided to the computing system.

87. The system of claim 85, wherein the system is an intermediate network node system.

88. The system of claim 87, wherein the system is a network switch.

89. The system of claim 85, wherein the system is a network endpoint system.

90. The system of claim 85, wherein the system is a network endpoint system having at least one server or at least one server card.

91. The system of claim 85, wherein the system is incorporated into a network interface card.

92. The system of claim 90, wherein the system is a content delivery system.

93. The system of claim 92, wherein the distributed interconnection is a switch fabric.

94. The system of claim 85, wherein system is an asymmetric multi-processing system.

95. The system of claim 85, wherein the plurality of system processor engines are configured to perform separate tasks.

96. The system of claim 95, wherein the distributed interconnection is a switch fabric and the task specific processor engines include storage or application processor engines.

97. The system of claim 96, wherein the task specific processor engines include storage and application processors.
